(19) United States
(12) Patent Application Publication
(10) Pub. No.: US 2006/0288101 A1
(43) Pub. Date: Dec. 21, 2006

(54) Multipurpose Interface and Control System

(75) Inventors: George Mastrodonato, Rochester, NY (US); Robert Anton, Penfield, NY (US); Benjamin Morley, Rochester, NY (US); Thomas Rockwell, Rochester, NY (US); James Arrow, Webster, NY (US); George Eckerdt, Fishers, NY (US)

Correspondence Address: BROWN & MICHAELS, PC;400 M & T BANK BUILDING, 118 NORTH TIOGA ST, ITHACA, NY, 14850, US

(73) Assignee: KEY SYSTEMS, INC., Fishers, NY (US)

(21) Appl. No.: 11/421,635

(22) Filed: Jun. 1, 2006

Related U.S. Application Data
(63) Continuation-in-part of application No. 10/644,383, filed on Aug. 19, 2003.
(60) Provisional application No. 60/686,181, filed on Jun. 1, 2005.

(51) Int. Cl. G06F 15/173

(52) U.S. Cl. 709/224

(57) ABSTRACT

A multipurpose interface and control system includes a managing and/or monitoring device (an “effectuator”) capable of monitoring parameter(s) and/or controlling function(s) of an apparatus, and a server system coupled to a communication medium, where the server system allows the effectuator (and via it the apparatus it monitors and/or controls) to be accessed remotely via the communication medium. The communication medium allows the effectuator to be accessed from remote locations by other devices capable of accessing the communications medium and thereby accessing the effectuator(s). The communications medium can take numerous forms, such as a direct connection, ethernet connection, internet connection, intranet connection, and/or phone connection. Preferably, the system includes at least one remote device capable of communicating with at least one effectuator via the communications medium (generally a network). The remote network enabled device(s) can include at least one of: telephones, computers, PDAs, and Kiosks. Further, the web server based firmware of the system ideally allows programming of the effectuator via the remote network enabled device(s) without software other than said server based firmware. However, software based in computer(s) constituting at least one of the web enabled device(s) can also be used to manage said effectuator(s).

### REFERENCE TO RELATED APPLICATIONS

This application is a continuation-in-part of co-pending application Ser. No. 10/644,383, filed Aug. 19, 2003, entitled “Tangible Security Asset Management System and Methods Therefor” and incorporates teachings and advances disclosed in Provisional Application No. 60/686,181, filed Jun. 1, 2005, entitled “Multipurpose Interface and Controller”. The benefit under 35 USC §119(e) of the U.S. provisional application is hereby claimed, and the aforementioned applications are hereby incorporated herein by reference.

### BACKGROUND OF THE INVENTION

1. Field of the Invention

The invention pertains generally to the fields of information and control technologies. More particularly, the invention pertains to a multipurpose interface and control system including a managing and/or monitoring device (an “effectuator”) capable of monitoring parameter(s) and/or controlling function(s) of an apparatus, and including a server system coupled to a communication medium, where the server system allows the device to be accessed remotely via the communication medium.

2. Description of Related Art

In an advanced and technological society, numerous parameters/devices are in constant need of monitoring and/or control. This need is especially felt in the field of security and safety. Thus, there is a constant need to monitor and/or control related to, for example, locks governing access and use of doorways and openings in hotels, houses, jails, and other secured areas. Likewise, the viability and functionality of useful apparatus such as fire extinguishers must be constantly monitored in order to assure that they are in functional order and able to be used in case of an emergency. Further, there is a continuing need to control tangible assets that, among other things, include personalty, keys and/or means for accessing any or all of the foregoing.

Where tangible personalty is concerned, employees, customers and others associated with organizations, such as prisons, casinos, vehicle fleet operators, schools, ambulance companies or governmental agencies and many others, often need to use a variety of the organization's tangible assets, such as specialized tools, knives, medicine, or keys to buildings, vehicles and file cabinets. Absolute control must often be maintained in these areas. Thus, e.g., medicine kept in an ambulance must be rigidly monitored and controlled to ensure that drug safety and use regulations are being complied with.

Further, it is often necessary to monitor and/or control devices such as locks, lock boxes, doors and so forth related to access and safety to limit potential losses and liability. Monitoring and controlling access and assets requires numerous things, such as knowing and controlling who has access to a particular asset or means of ingress/egress, knowing who has exercised access, knowing when access was exercised, and knowing when access was ended (e.g., by returning an asset and/or closing a door), as well as other information.

As to tangible asset control and access, the above-noted issues are being partially dealt with by electronically based systems, such as systems used to manage keys. Referring to FIG. 1A, an exemplary prior art system 10 includes a plurality of key control units 12 as shown. Each of the key control units 12 comprises a key access control system 14 that can monitor the use of a set of keys corresponding to assigned key bays (not illustrated) in each of the systems 14. Further, each of the key access control systems 14 is coupled to a PC management system 18 via an I/O 16. For instance, a user may checkout a key from a bay in one of the key control units 12 by inputting a pin code into a keypad controller unit on the key control unit 12 (not illustrated). The keypad controller unit then checks its records for determining whether to permit or refuse access to the key based on the inputted pin code. Additionally, the PC management system 18 polls the key control units 12 from time to time or when requested by a user to download transaction records and to deliver programming updates (e.g., add/delete user accounts) to the units 12.

This exemplary system 10 works, but the I/O 16 in each key control unit 12 is limited in the types of systems it can communicate with and the types of functions it can perform. Connecting each of the key control units 12 to the PC management system 18 involves complicated hardware connections. Providing remote devices with access to each of the key control units 12 using the PC management system 18 would also involve complicated hardware connections. Once the system 10 is in place, upgrading one of the key control units 12 requires upgrading all of the units 12 resulting in the expenditure of a significant amount of labor. Another disadvantage is that if the PC management system 18 becomes inaccessible then none of the key control units 12 can be accessed, polled or updated. Also, requiring the PC management system 18 to poll the key control units 12 for delivering programming updates or downloading transaction records is disadvantageous for several reasons. The PC management system 18 may not always have the most current transaction information since the system 18 must poll the key control units 12 each time to obtain the information. Likewise, the key control units 12 may not always have the most current programming. Additionally, having one point of contact and processing at the management system 18 further limits the types of functions and features of the system 10.

The parent application (Ser. No. 10/644,383) of this Continuation-in-Part application represents an enormous advance over prior art. As illustrated in FIG. 1B, it teaches an asset management system 30 that includes one or more security asset managers 32(1)-32(n) each having an asset control system 34 and a web server 36, where each of the security asset managers 32(1)-32(n) is coupled directly to a remote system 40 via a communications medium such as Internet 42, although other types of communication networks could be used. The asset management system 30 enables the remote system 40 to communicate directly with each of the security asset managers 32(1)-32(n) to ensure the remote system 40 receives current transaction information, ensure the managers 21 are able to receive current software upgrades, and to allow the remote system 40 to control the security asset managers 32(1)-32(n) resulting in a simpler system 30 which uses less power and has greater overall performance.

The web server 36 executes at least a portion of programmed instructions stored in the memory for managing assets as described and illustrated herein, although the web server 36 may comprise circuitry hardwired to perform these functions, such as an ASIC chip. The memory comprises any type of fixed or portable memory accessible by the web server 36, such as ROM, RAM, SRAM, DRAM, DDRAM, hard and floppy-disks, CDs, DVDs, magnetic tape, optical disk, ferroelectric and ferromagnetic memory, electrically erasable programmable read only memory, flash memory, charge coupled devices, smart cards, or any other type of computer-readable media. The memory stores the programmed instructions as well as other information, although the instructions may be stored elsewhere. The I/O unit couples the web server 36 to the Internet 42 and comprises an Ethernet interface, although other types of interfaces may be used including RS232, RS485, and wireless communication interfaces.

The remote system 40 comprises a desktop personal computer with a processor, memory, user input devices (e.g., mouse and keyboard), output devices (e.g., monitor and/or printer) and an I/O unit, which are coupled together by one or more bus systems or other communication links (not illustrated), although the system 40 may comprise other types of computers and systems including cellular telephones, PDA devices, and laptop computers. Although just one remote system 40 is illustrated, it should be appreciated that one or more remote systems will typically be used. The processor executes at least a portion of programmed instructions stored in the memory of the remote system 40 for managing assets as described and illustrated herein, although the processor may comprise circuitry hardwired to perform these functions, such as an ASIC chip. The memory in the remote system 40 comprises the same type of memory used in the security asset managers 32(1)-32(n), although other types of memory may be used. The memory stores the programmed instructions as well as other information, although the instructions may be stored elsewhere. Further, the I/O unit provides the system 40 with access to the Internet 42 and comprises the same type of I/O unit used in the web server 36, although other types of I/O units may be used.

The Internet 42 enables the security asset managers 32(1)-32(n) and the remote system 40 to communicate with each other, although other communication mediums could be used. In embodiments of the present invention, the Internet 42 comprises a TCP/IP network, such as the World Wide Web, although other types of line-based networks may be used, such as Intranets (e.g., LANs, WANs) using telephone line and/or coaxial cable, ISDN networks, as well as wireless networks (e.g., satellite, IR, radio), and combinations thereof.

Thus, the parent application describes an invention providing numerous advantages over prior art. By providing each one of the security asset managers 32 with a web server 36, each of the security asset managers 32 can be accessed directly by remote devices 40 on a network 42. The remote systems are able to obtain current transaction records from the security asset managers 32, provide the security asset managers 32 with programming updates and actually control the security asset managers 32. Since the security asset managers 32 do not need to rely on any intermediate systems, the invention described in the parent application offers a simpler way to interconnect the security asset managers 32 which uses less power overall. This results in a more robust system since the security asset managers 32 can function independently as a result of not having to rely on the intermediate systems. Further, remote systems 40 can more easily access the security asset managers 32 directly resulting in enhanced system performance. Each security asset manager 32 can be modified, upgraded and/or replaced without affecting any of the other security asset managers 32 that are not being changed. Additionally, the system can continue to operate despite one or more of the security asset managers 32 becoming inaccessible. However, despite the great advance represented by the teachings of the parent application, there remain numerous useful applications for, and advances based upon, the technological advance outlined therein.

### SUMMARY OF THE INVENTION

The instant invention includes a multipurpose interface and control system including a managing and/or monitoring device capable of monitoring parameter(s) and/or controlling function(s) of an apparatus, that includes a server system coupled to a communication medium, where the server system allows the device (and via it the apparatus it monitors and/or controls) to be accessed remotely via the communication medium. Thus, from the standpoint of the parent application, the instant application broadens the applicability of the base concept beyond that of merely monitoring and/or controlling a security asset manager (a “SAM”), to monitoring and/or controlling any of a variety of different devices, such as SAMs, hotel doors, jail doors, fire extinguishers, thermostats, sensors, and/or numerous other types of devices, particularly those intended for security and safety purposes. As such, the heart of our invention is a multi-purpose managing and/or monitoring device (hereinafter referred to as an “effectuator”). Each effectuator is capable of monitoring parameter(s) and/or controlling function(s) of an apparatus or apparatuses, and can take a variety of forms as dictated by the apparatus or apparatuses it serves. The communication medium (generally referred to in the specification generically as a “network”) allows the effectuator to be accessed from remote locations by other devices capable of accessing the network and thereby accessing the effectuator(s). The communications medium can take numerous forms, such as a direct connection, ethernet connection, internet connection, intranet connection, and/or phone connection. However, for the purposes of discussing the preferred embodiments of the invention the communications medium will hereafter be referred to as a “network”, it being understood that this term is to be interpreted comprehensively.

From the foregoing it is clear that our invention significantly revises and extends the scope and applicability of the inventive concept beyond that required for the monitoring and/or control of SAMs. However, as in the parent application, the invention taught herein includes at least one remote device capable of communicating with at least one effectuator via the network. In view of the choice of the term “network” for the communications medium, this remote device is hereinafter referred to as a remote network or web enabled device, it being understood once more that this is not intended as limiting terminology. Given the foregoing, the server system of effectuator(s) will typically take the form of a web server and will have web server based firmware allowing the programming of the effectuator(s) via said at least one remote network enabled device(s). The remote network enabled device(s) can include at least one of: telephones, computers, PDAs, and Kiosks. Further, the web server based firmware of the system ideally allows programming of the effectuator via the remote network enabled device(s) without software other than said server based firmware. However, software based in computer(s) constituting at least one of the web enabled device(s) can supplement the operations of the basic system in numerous ways and is also described below, as are numerous other preferred aspects of the invention

### BRIEF DESCRIPTION OF THE DRAWING

FIG. 1A provides a schematic overview of an exemplary prior art system for managing keys.

FIG. 1B provides a schematic overview of an asset management system in accordance with the parent application.

FIG. 1C provides a high level schematic overview of the entire system of our current invention.

FIG. 2A provides a schematic illustration of a first exemplary application of our invention.

FIG. 2B provides a schematic illustration of a second exemplary application of our invention.

FIG. 3 provides a schematic illustration of the web-server firmware architecture of an effectuator 200 of our invention.

FIG. 4 provides a schematic type flow-chart diagram of the Rule Processing system of our invention.

FIG. 5A provides an overview illustrating initiation of communications functions by the communications software of the invention.

FIG. 5B provides an overview illustrating communications functions by the communications software of the invention following initialization.

FIG. 6 provides a state diagram illustrating a SWAT/effectuator session as referenced in FIG. 5.

FIG. 7 provides a state diagram illustrating a Tray session/application as referenced in FIG. 5.

FIG. 8A provides a schematic diagram illustrating the programming of the effectuator 200 via installed PC user interface application directly by a user.

FIG. 8B provides a schematic diagram illustrating the programming of the effectuator 200 via installed PC user interface application by inputting the customer's personal data base.

FIG. 9 provides a schematic diagram illustrating an exemplary connection between three effectuators and a managing computer.

FIG. 10 provides an exemplary screen shot showing a customizable site map, where icon placement on the map denotes the placement of effectuators in certain physical locations designated on the map.

FIG. 11A provides an exemplary screen shot illustrating a basic information and monitoring page produced by the firmware of the invention. This status page corresponds to the “main” page button in FIGS. 11A-11F. It provides status on all apparatus(es) monitored. It also illustrates how clicking on one of the effectuator icons in FIG. 10 will lead to a status page providing further information related to the status of the effectuator referenced by the icon.

FIG. 11B is a status page produced by the firmware of the invention when “users” in FIGS. 11A-11F is clicked. It provides a list of authorized users.

FIG. 11C is a status page produced by the firmware of the invention when “groups” in FIGS. 11A-11F is clicked. It provides a list of authorized groups of users.

FIG. 11D is a status page produced by the firmware of the invention when “keys” in FIGS. 11A-11F is clicked. It provides further status on all apparatus(es) monitored.

FIG. 11E is a status page produced by the firmware of the invention when “rules” in FIGS. 11A-11F is clicked. It provides a screen for writing and re-writing rules related to apparatus(es).

FIG. 11F is a status page produced by the firmware of the invention when “panel” in FIGS. 11A-11F is clicked. It provides network configuration, alarm timer, hardware configuration and other information.

FIG. 12 provides a schematic diagram illustrating a situation where database software application, communications software application, and user interface software application are all running on the same PC.

FIG. 13 provides a schematic diagram illustrating a situation where the database software application and the user interface software application are both running on the same PC, and the communications software application is running on a different PC.

FIG. 14 provides a schematic diagram illustrating a situation where the database software application, the communications software application, and user interface software application are all running on different PCs.

FIG. 15 provides a schematic diagram describing the programmable entities in the user interface software and the functions thereof.

FIG. 16 provides a schematic overview of the entire system of our invention and provides additional details on how various drawing figures interrelate.

FIG. 17 provides a basic schematic illustration of a basic SWAT unit/box suitable for use as an effectuator in accordance with the teachings of our invention. (“SWAT” is an acronym for the inventive system, standing for Secured-Web Enabled-Access-Technology.)

FIG. 18 provides a schematic breakdown of the electrical and electronic components of the SWAT unit/box illustrated in FIG. 17.

FIG. 19 provides a schematic diagram of a security asset manager in accordance with the teachings of our invention.

FIG. 20A provides illustration of a sleeve and other components of a basic SWAT box suitable for use as an effectuator in accordance with the teachings of our invention (a drawer thereof if omitted). The illustration emphasizes the mechanical components thereof and in particular, the fact that the drawer of the unit is slidable in a sleeve embedded in a wall or other structure.

FIG. 20B provides an illustration of a drawer and other components of a basic SWAT box suitable for use as an effectuator in accordance with the teachings of our invention, showing the drawer withdrawn from its sleeve (the sleeve is omitted).

FIG. 20C provides an illustration of a drawer and other components of a basic SWAT box suitable for use as an effectuator in accordance with the teachings of our invention, showing the drawer as it is being slid in prior to contact between its locking solenoid pin and latch arm (the sleeve is omitted).

FIG. 20D provides an illustration of a drawer and other components of a basic SWAT box suitable for use as an effectuator in accordance with the teachings of our invention, showing the drawer after it has been slid into position in the sleeve and the latch arm, which is pivotable on the solenoid pin of an emergency release solenoid, is latched (the sleeve is omitted).

FIG. 20E provides an illustration of a drawer and other components of a basic SWAT box suitable for use as an effectuator in accordance with the teachings of our invention (the sleeve is omitted); showing the step 1 of an emergency release, after the pin of the emergency release solenoid has been withdrawn.

FIG. 20F provides an illustration of a drawer and other components of a basic SWAT box suitable for use as an effectuator in accordance with the teachings of our invention (the sleeve is omitted), showing step 2 of an emergency release, after the drawer moves forward with the released latch arm still hooked over the locking solenoid pin.

FIG. 21A through 21D illustrate the interaction and functioning of the slide in detent bracket and drawer (or tray) of the previously illustrated SWAT box.

FIGS. 22A through 22C show an alternate SWAT box emergency release and latching arrangement.

### DETAILED DESCRIPTION OF THE INVENTION

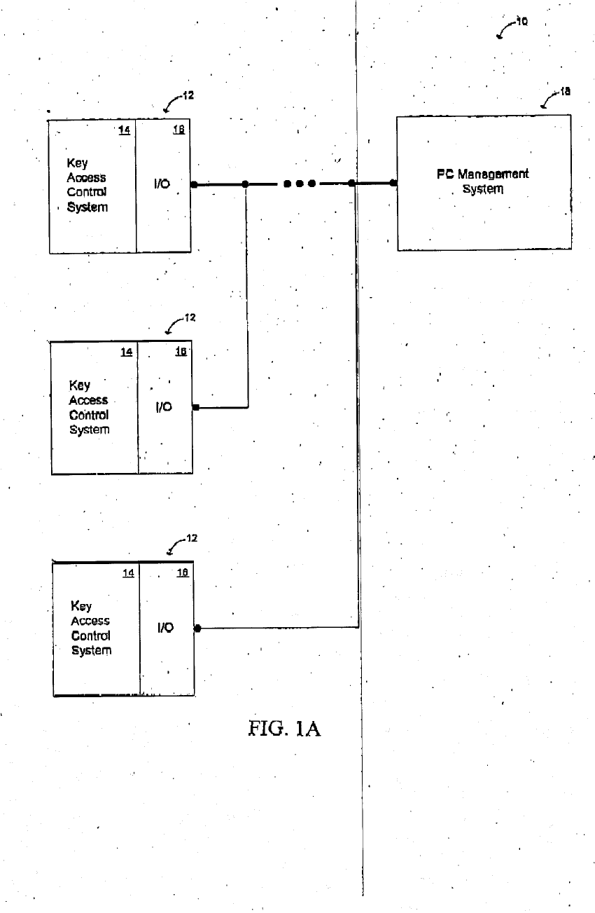

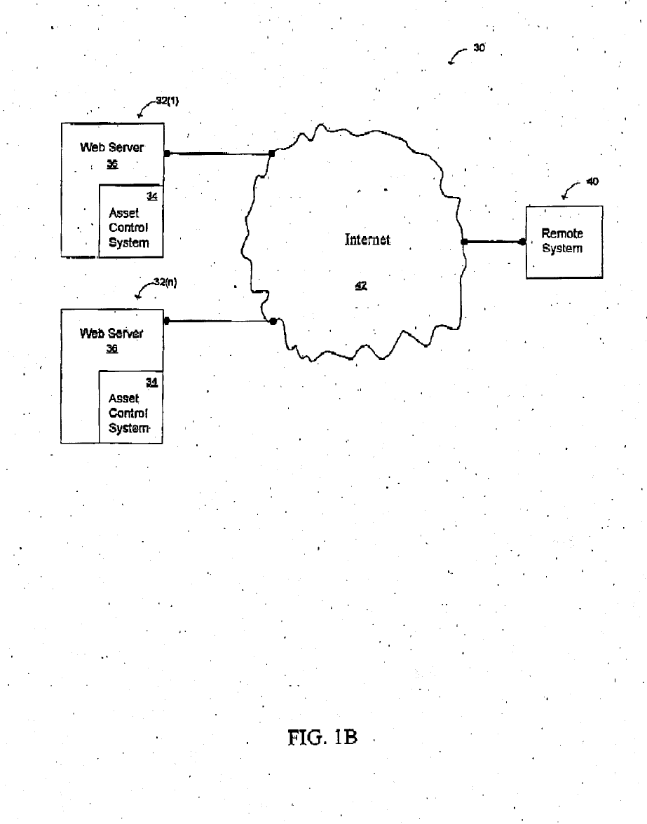

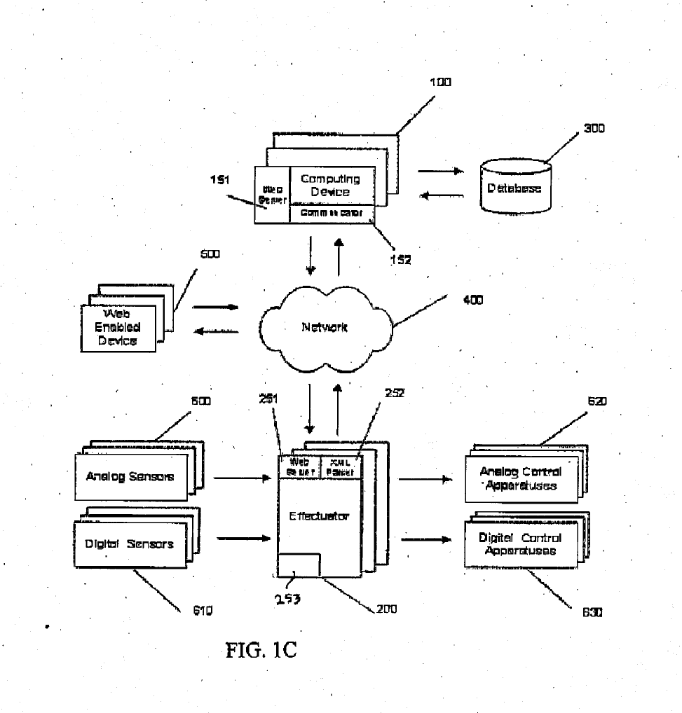

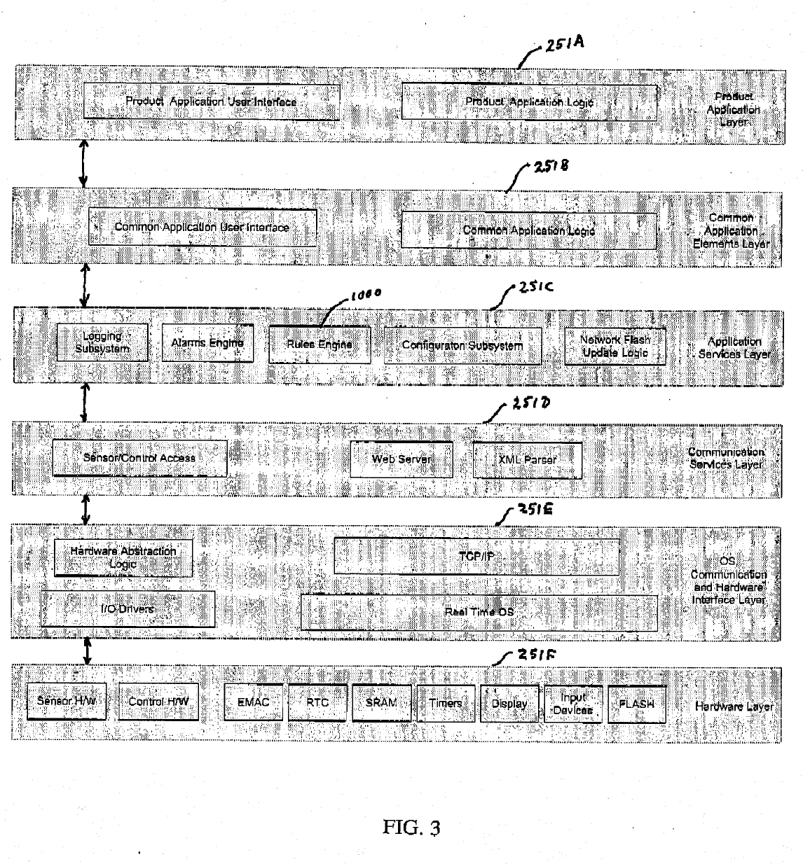

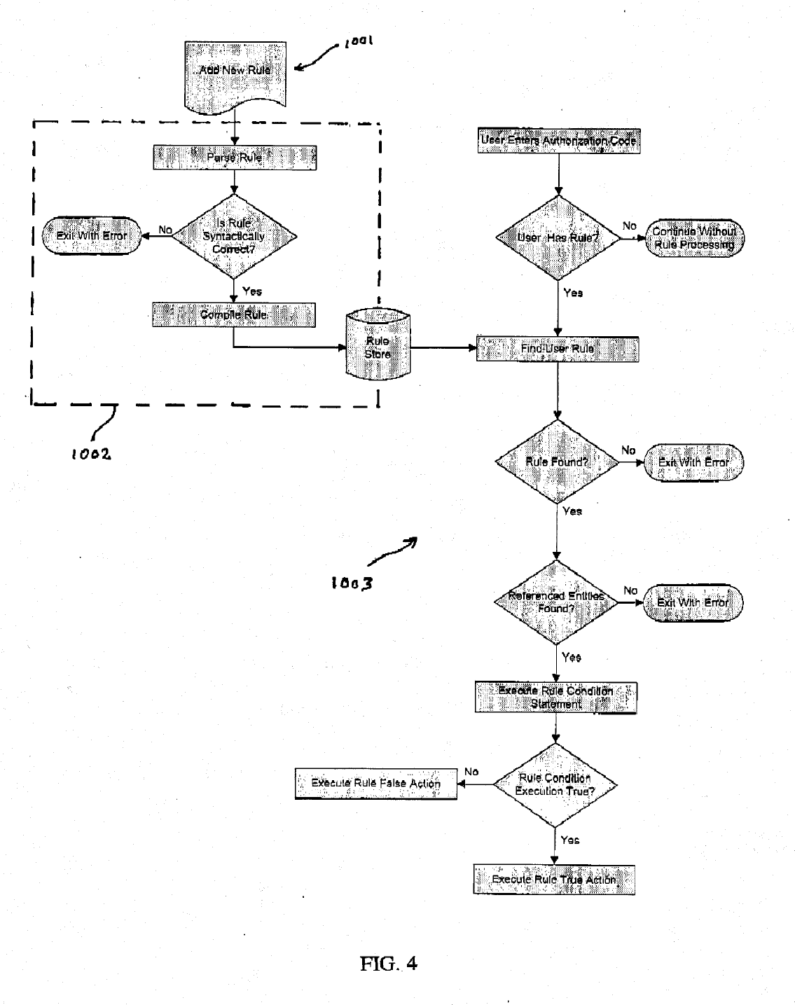

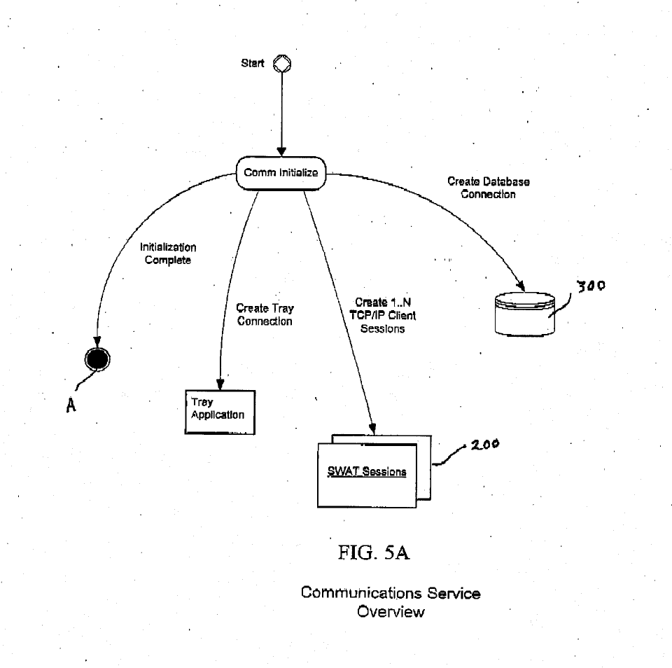

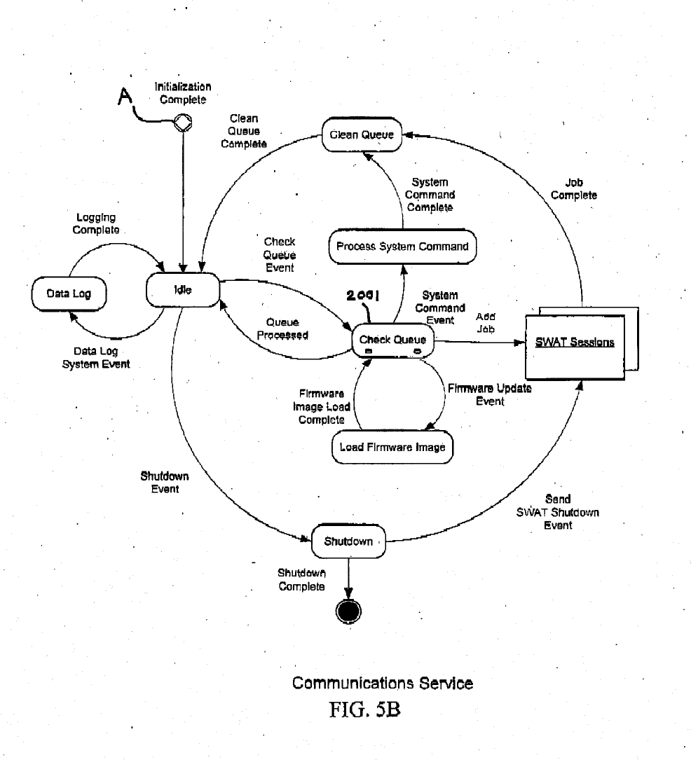

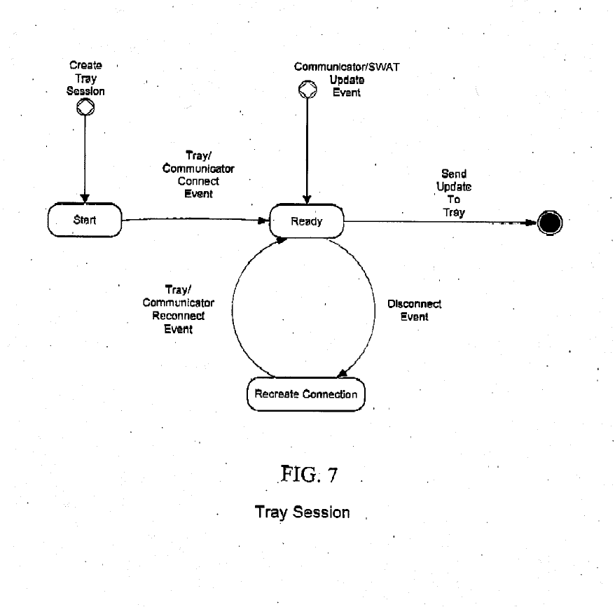

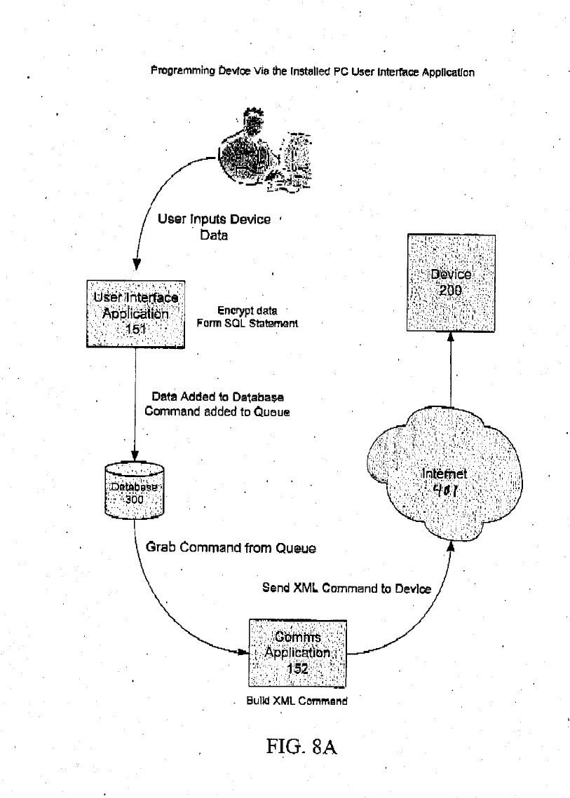

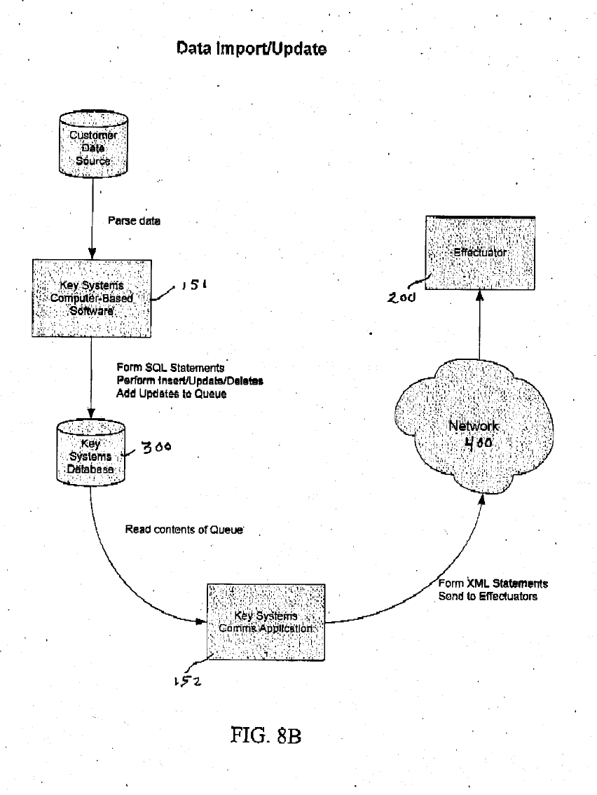

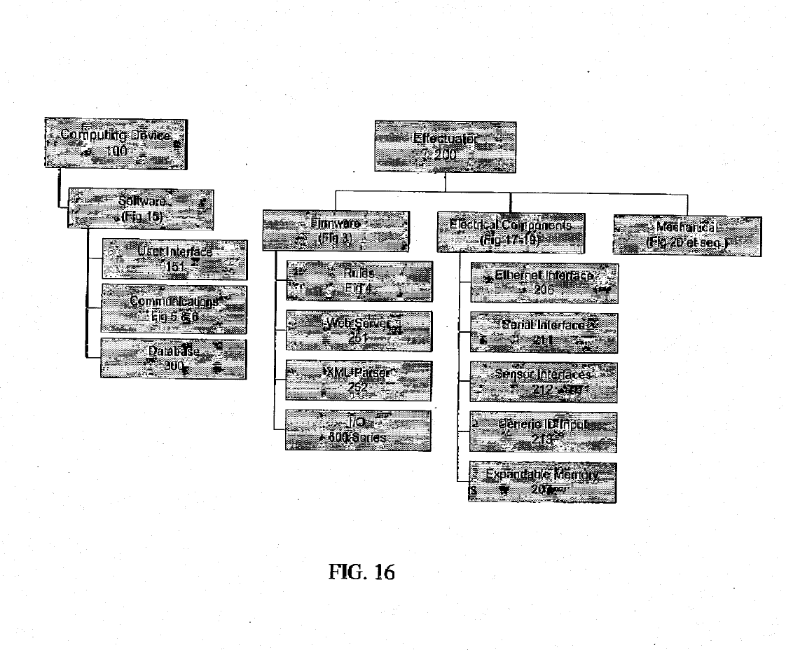

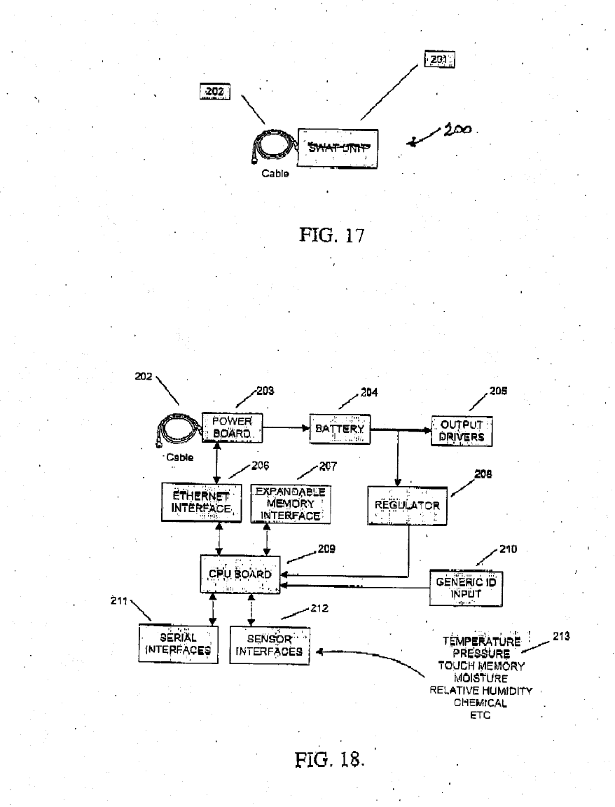

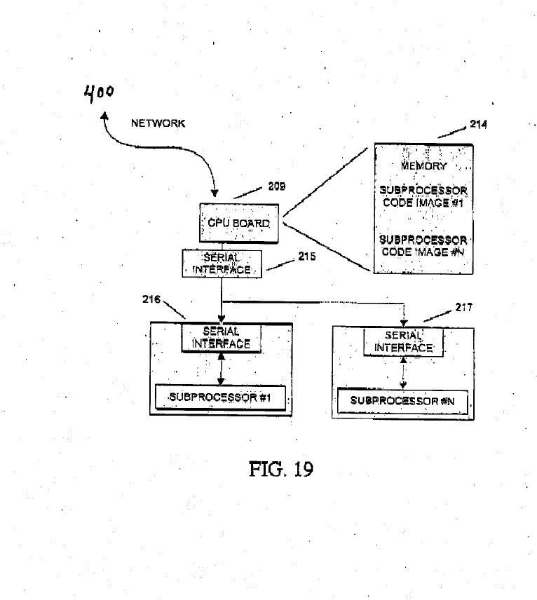

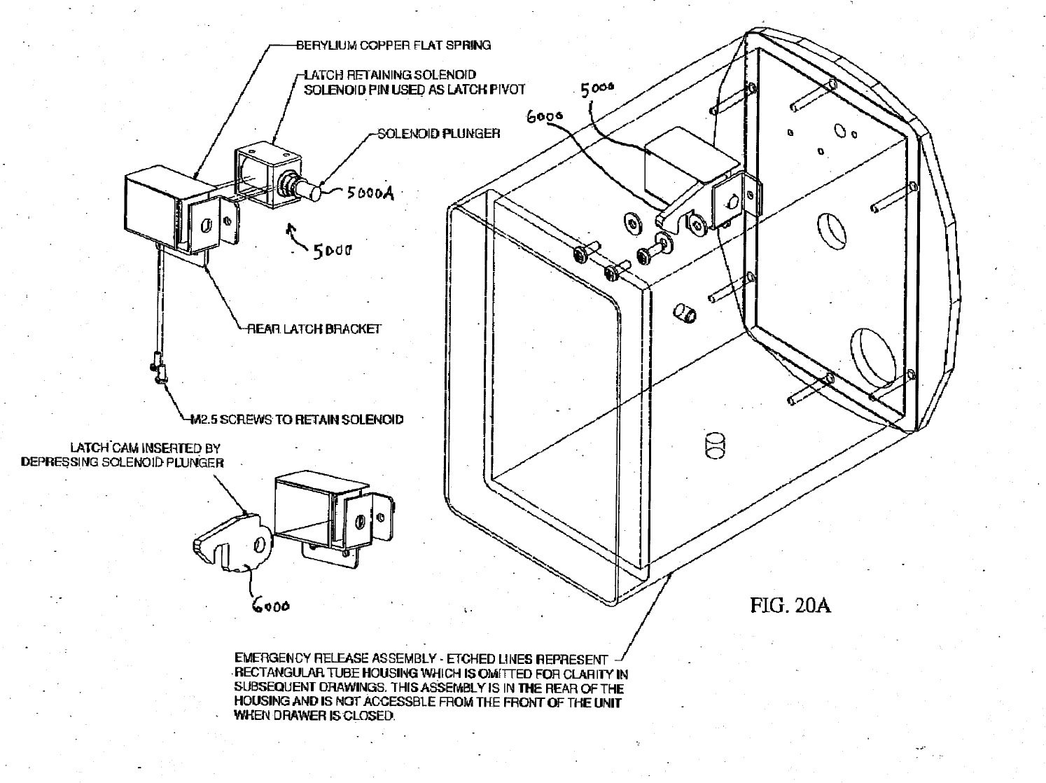

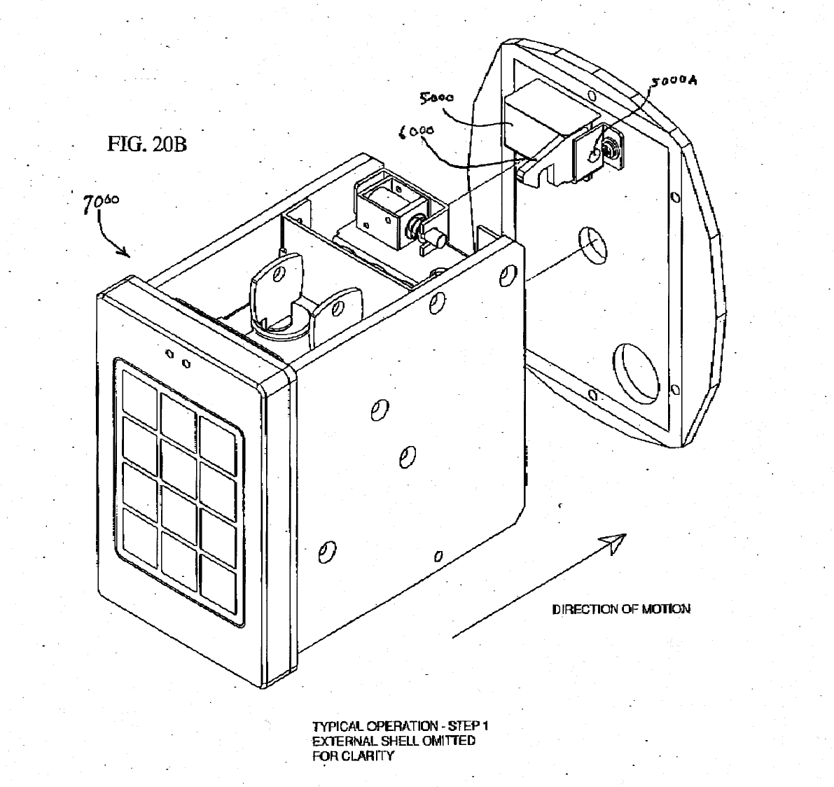

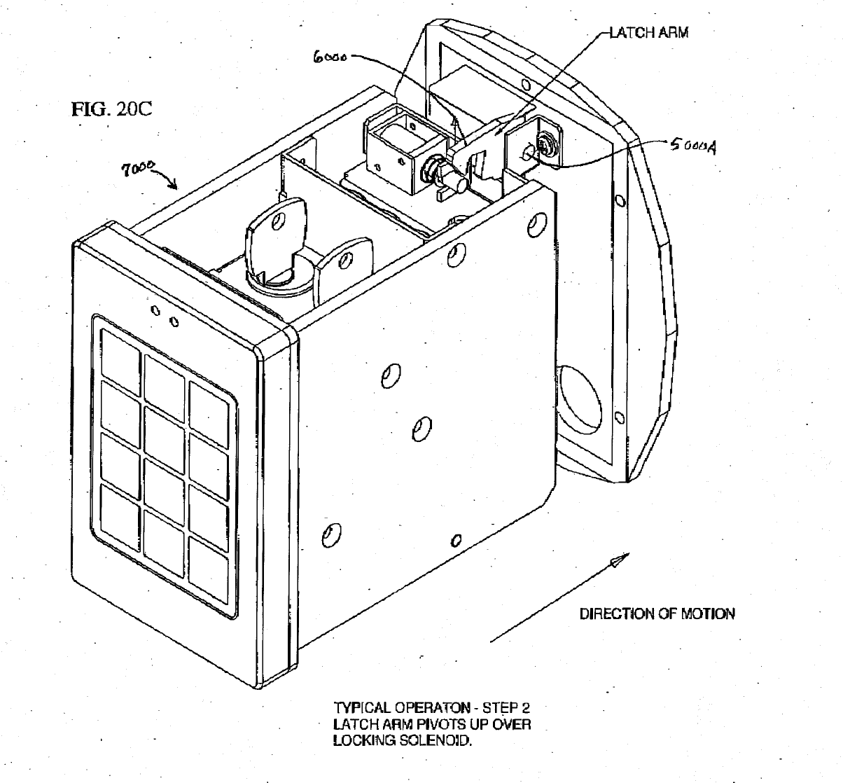

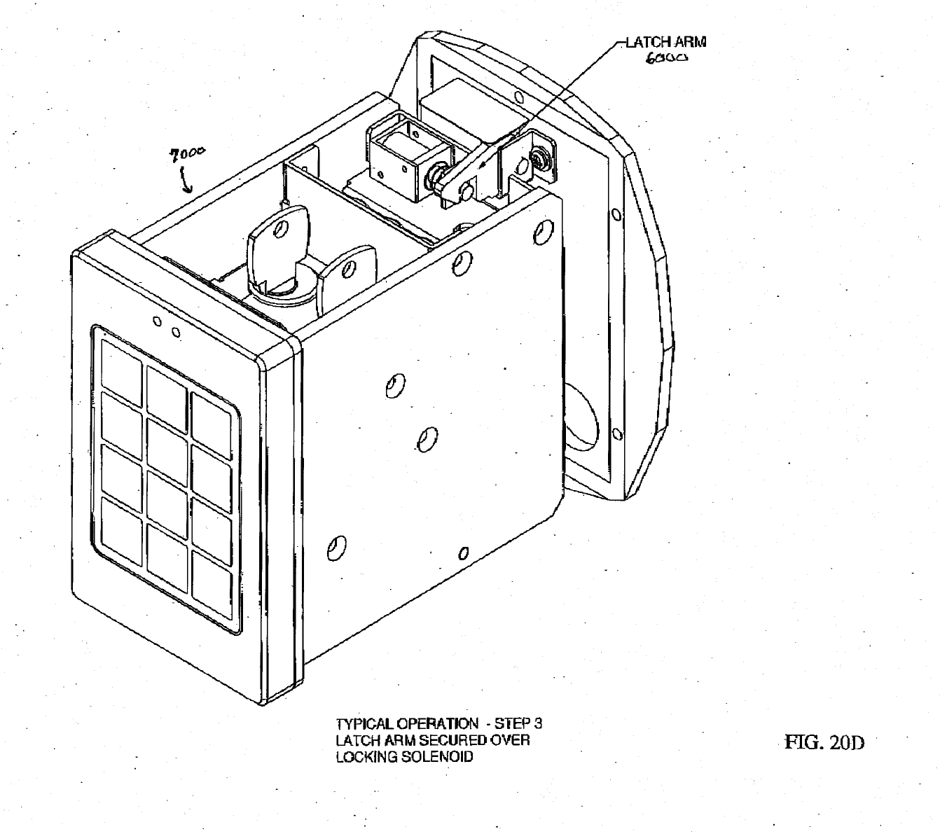

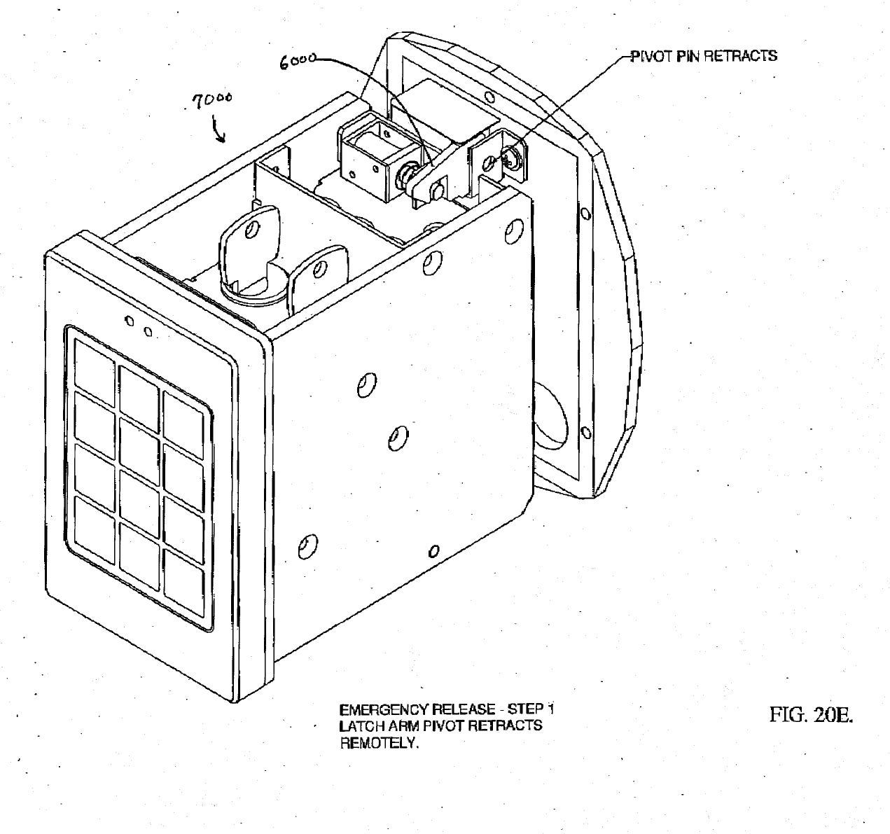

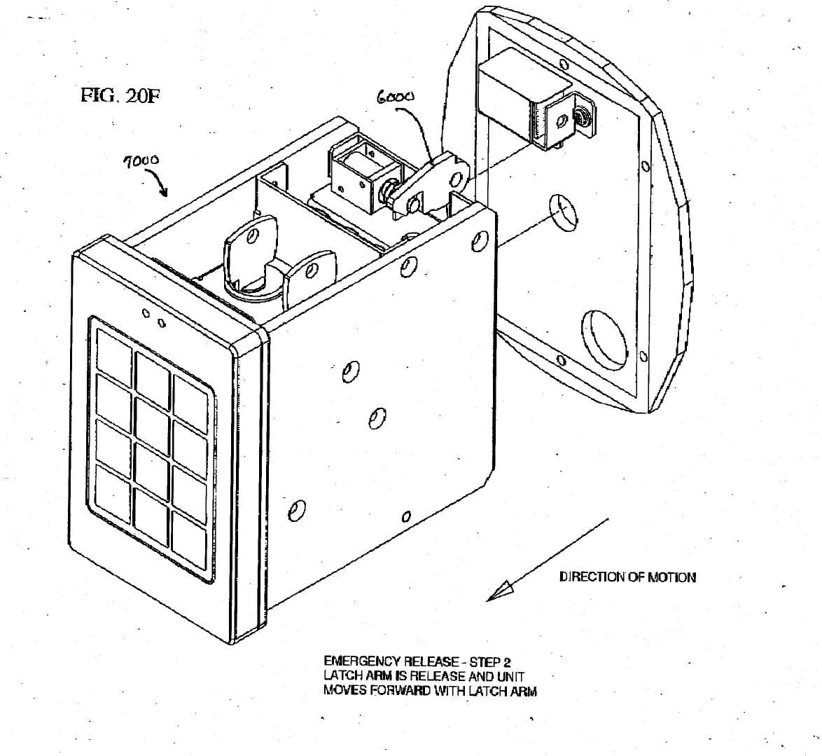

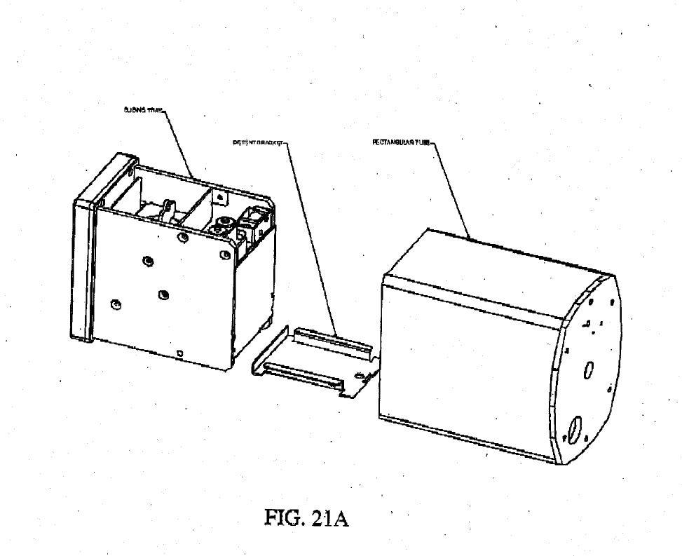

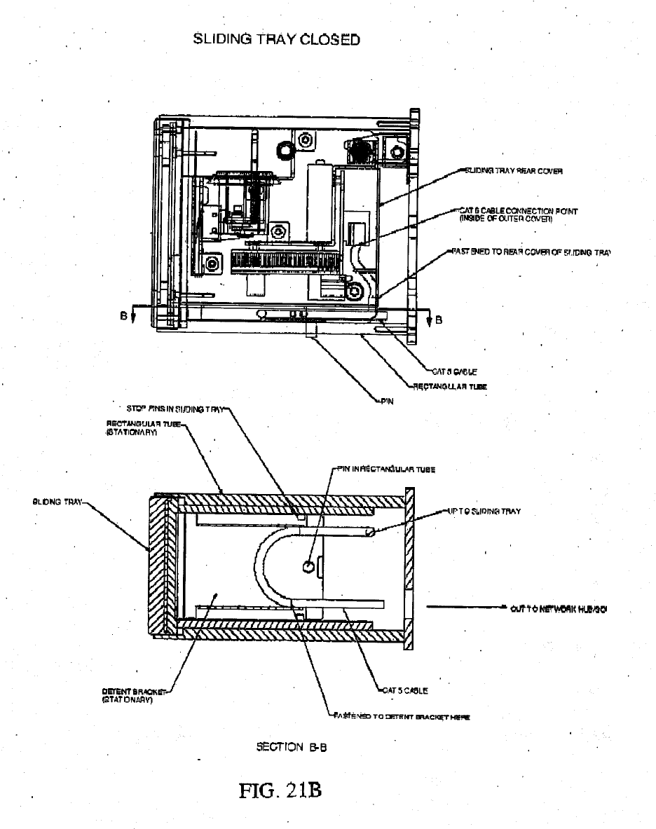

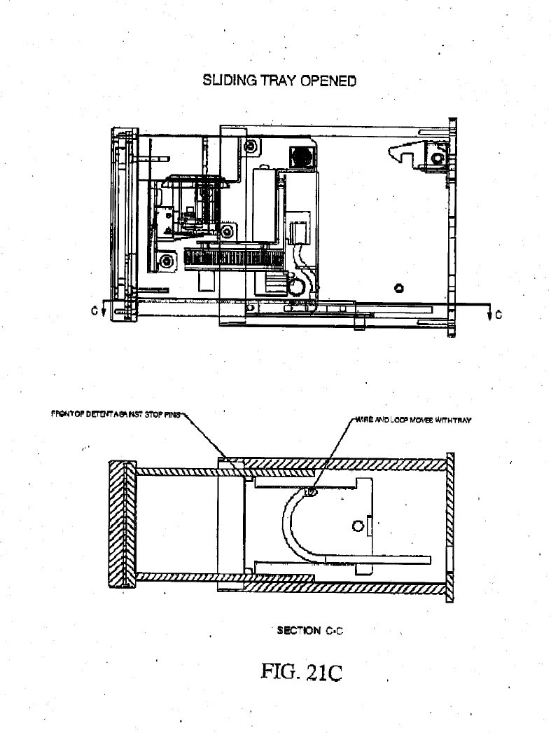

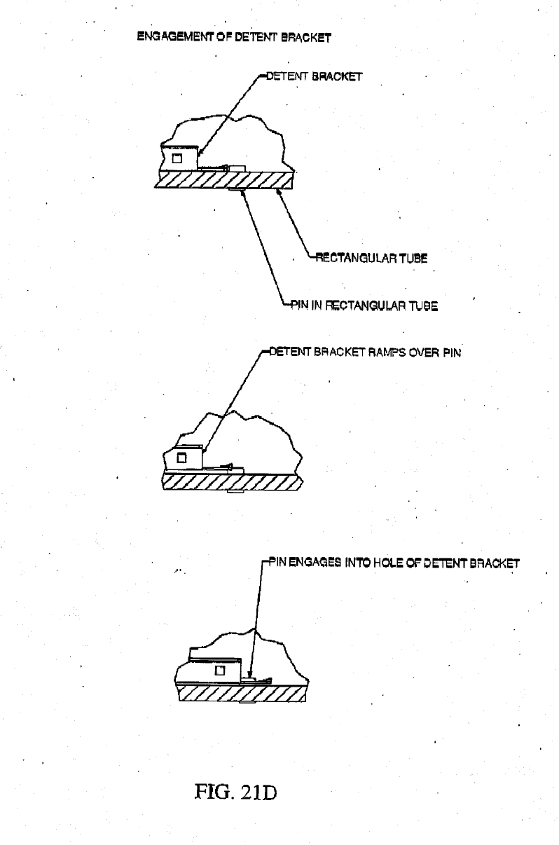

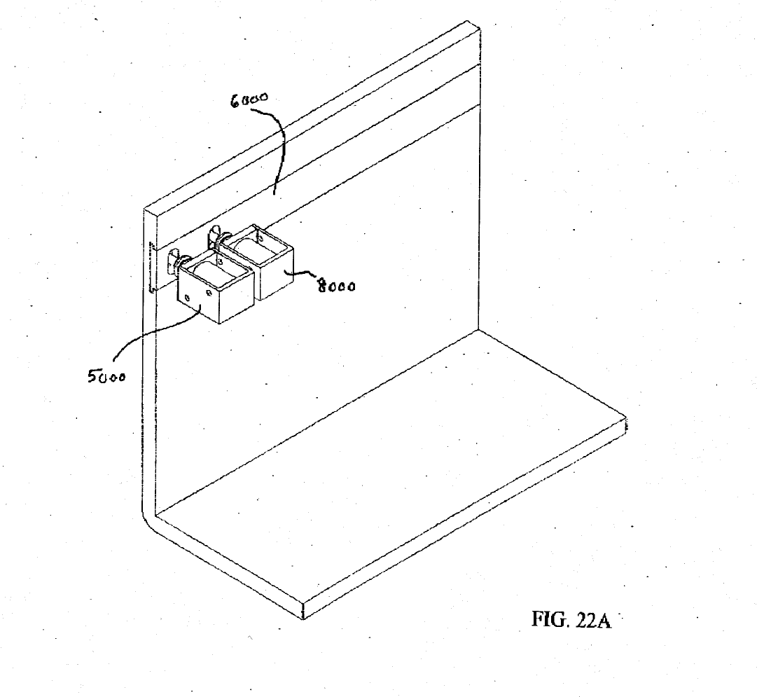

The invention is multifaceted, and ranges from simple and more general concepts and applications to extremely detailed variations and preferred embodiments. The following detailed description first discusses the inventive concept and its embodying hardware, firmware and software in general terms in relation to FIGS. 1C, 2A, 2B, 9, 11A through 11F, 12, 13, 14 and 16. It then focuses on details related to preferred forms and features of the web server based firmware of the invention in relation to FIGS. 3 and 4. This is followed by a discussion of communications issues related to the invention in relation to FIGS. 5A, 5B, 6 and 7; details related to preferred forms and features of the remote managing computer based software of the invention in relation to FIGS. 8, 9, 10 and 11; details related to preferred forms and features of the electrical components of the invention in relation to FIGS. 17, 18 and 19; and a discussion of details related to preferred forms and features of an effectuator 200 served apparatus of the invention (a “SWAT BOX”) in relation to FIGS. 20A through 21D.

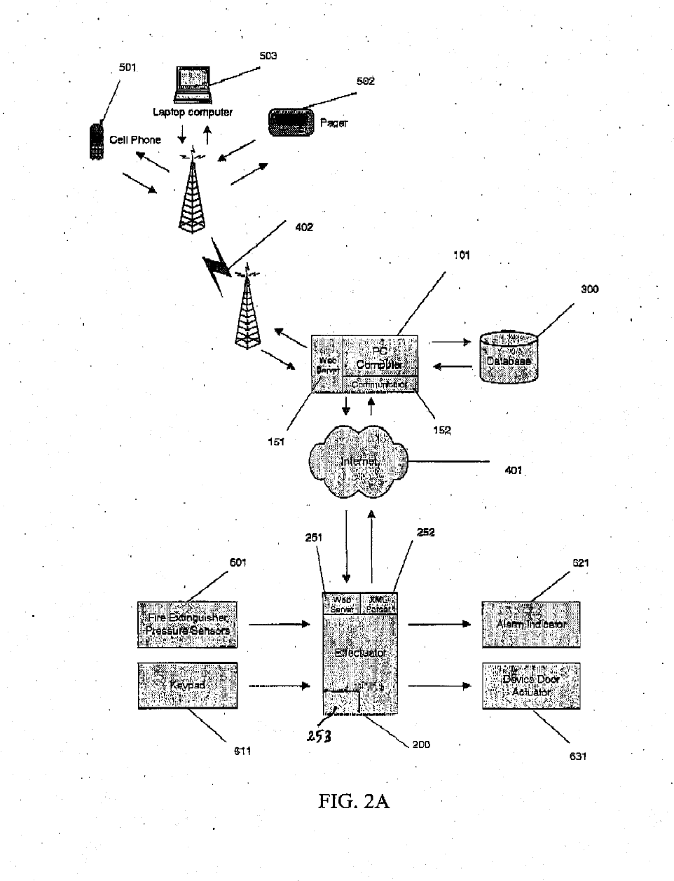

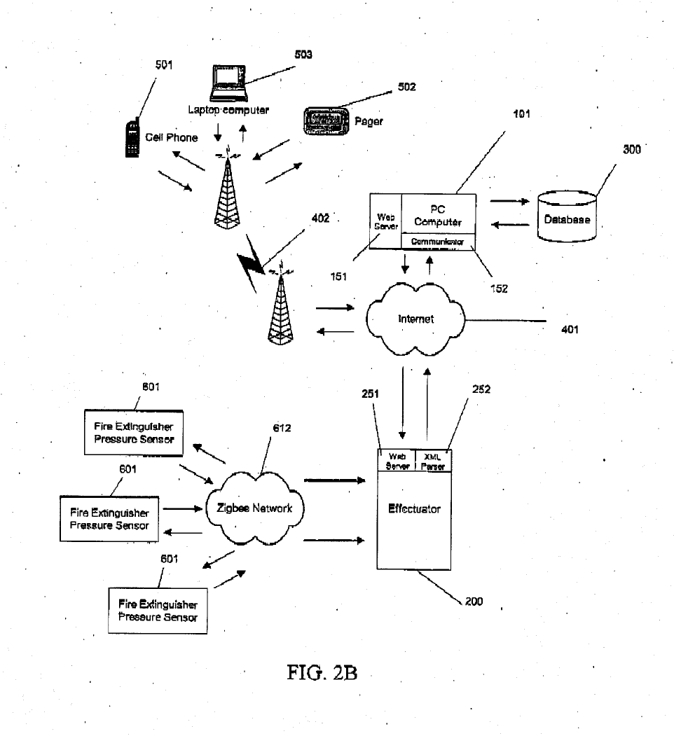

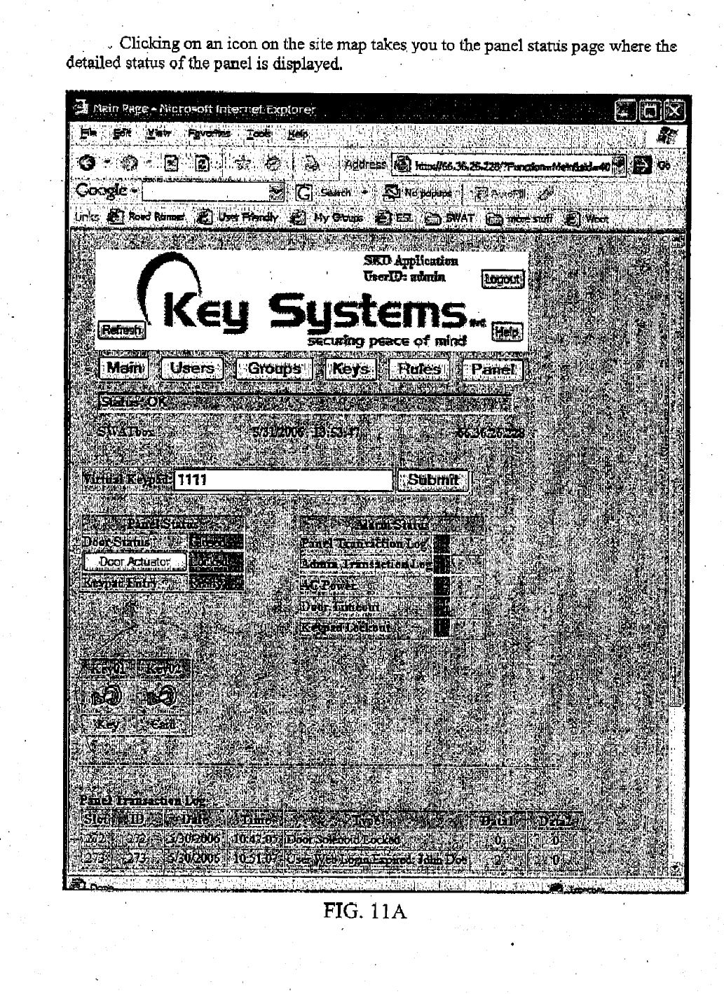

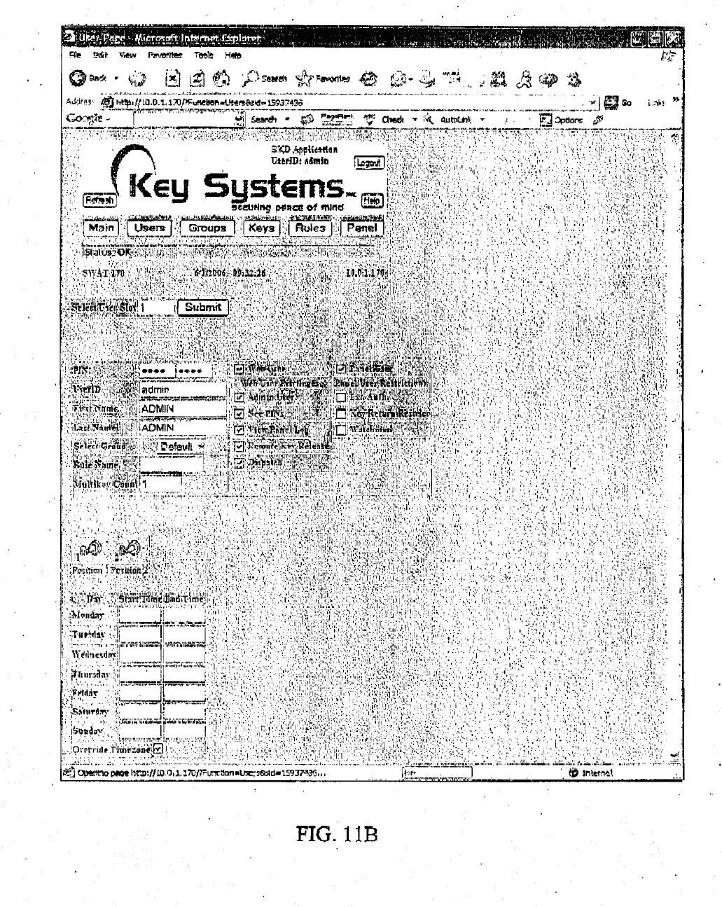

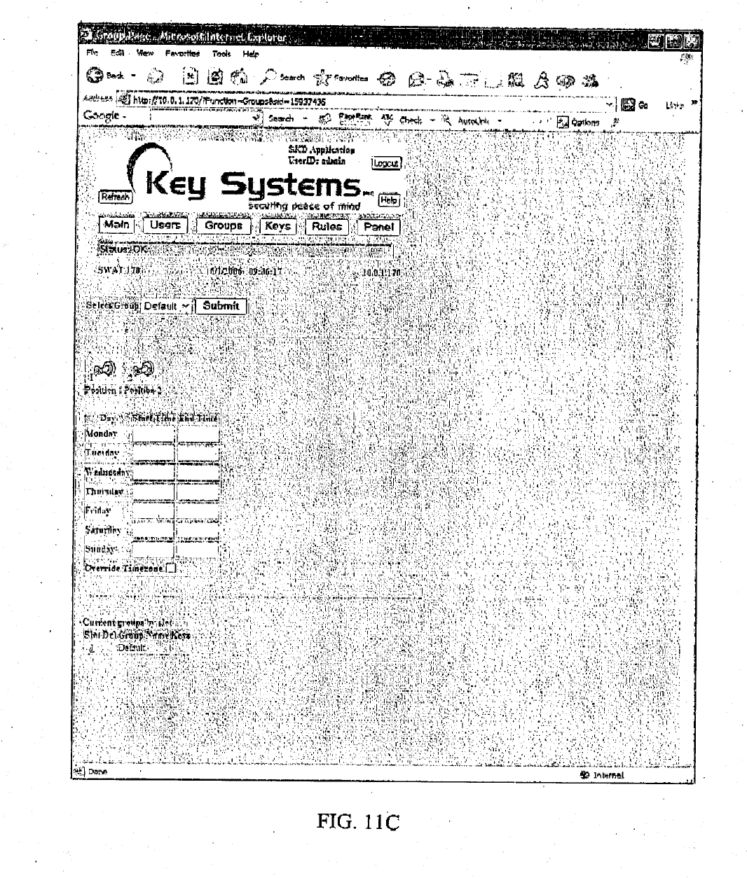

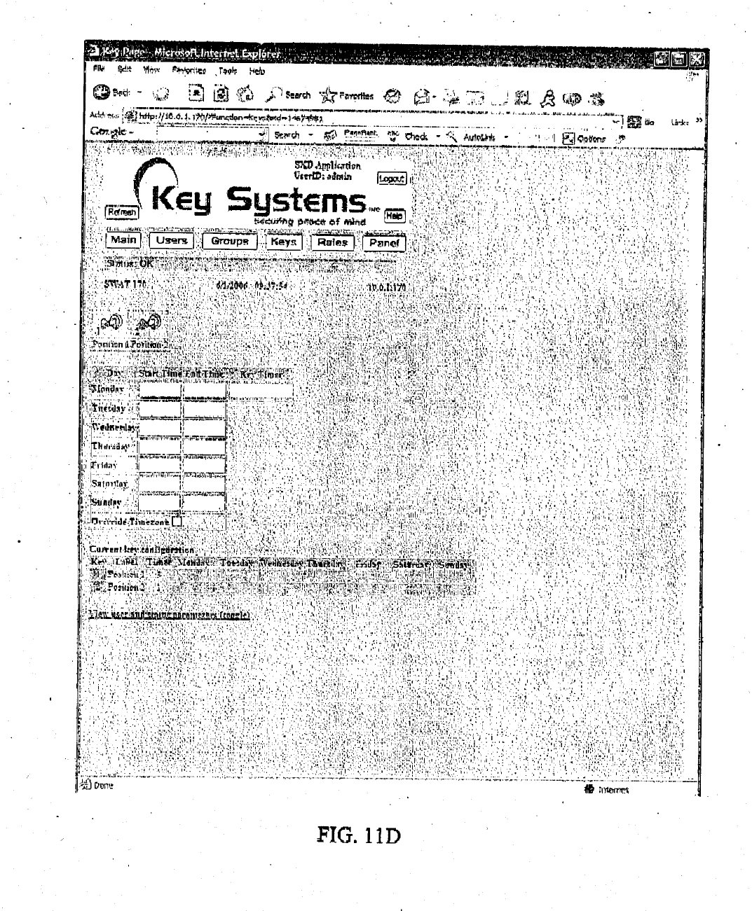

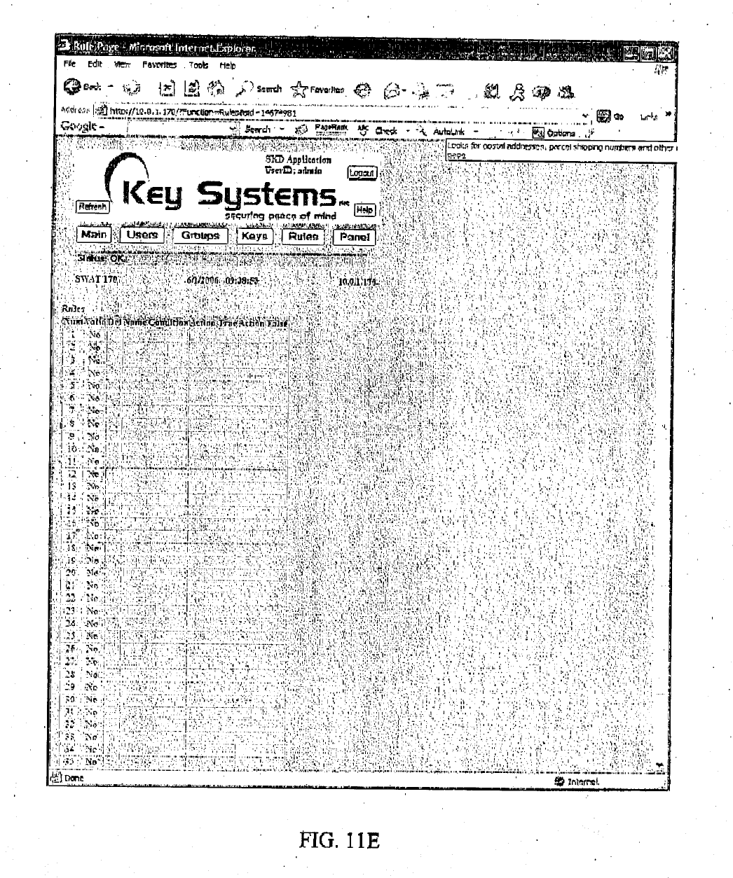

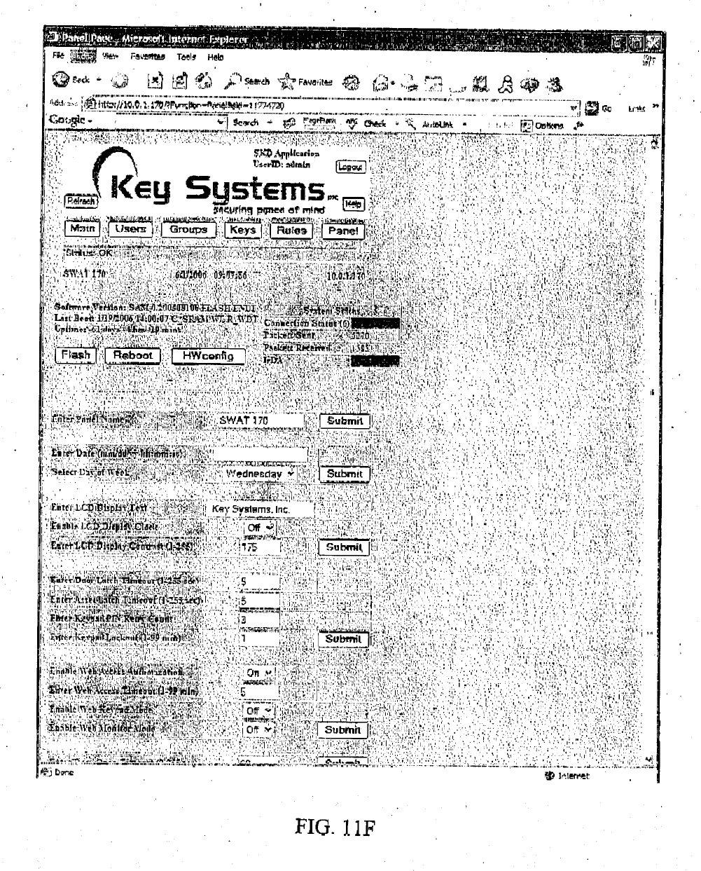

As illustrated in FIGS. 1C through 2B, the instant invention describes a multipurpose interface and control system including at least one managing and/or monitoring device (effectuator 200) capable of monitoring parameter(s) and/or controlling function(s) of an apparatus and a server system (such as web server 251) coupled to a communication medium (network 400 or internet 401). (The terms “web server”, “server system”, and “network server” as used herein comprehend both software and hardware used for these purposes). The apparatus(es), as illustrated in FIG. 1C, can include items such as analog sensors 600, digital sensors 610, analog control apparatuses 620, and digital control apparatuses 630. A first example is provided in FIG. 2A, where such apparatuses include fire extinguisher pressure sensors 601, a keypad 611, an alarm indicator 621, and a device door actuator 631. Each effectuator 200 is provided with a system server (exemplified by web server 251 in FIG. 1C) that allows the effectuator 200 (and via it the apparatus(es) 600, 610, 620, 630 it monitors and/or controls) to be accessed remotely via the network 400 and is also capable of storing information (such as programming and operational records) related to operations of the at least one system effectuator 200 and the apparatuses 600, 610, 620, 630 it monitors and/or controls. (See, e.g., FIGS. 11A through 11F which represent exemplary interface pages produced by the firmware for use and accessible by an authorized remote network enabled device 100, 500). An at least one remote device (such as remote managing computer(s) 100 or other remote network enabled device(s) 500 can access the at least one system effectuator 200 via the communications medium (network 400) and the server system 251 so as to at least one of: monitor and control said apparatus(es) 600, 610, 620, and 630 via said effectuator 200. (See, further explanation in reference to FIGS. 11A through 11F, below).

The foregoing allows an effectuator 200 or a system of effectuators 200 to be controlled and monitored via their built-in web server(s) 251 using any network-enabled devices, such as (in the case where network 400 is the internet 401) phones, PCs, PDAs pagers and Kiosks (denoted generally as 500 in FIG. 1C) as well as managing computers 100. Using this technology, the system of the invention is capable of remotely monitoring and/or controlling any of a variety of different devices. Such devices will generally fall into the category of access control apparatus(es), sensor apparatus(es), and/or system control apparatus(es). Access control apparatus(es), including ingress/egress control apparatus(es) include applications such as lockboxes, safes, SAMs, hotel doors, home doors, gateways, commercial facility doors, and jail doors. (See, e.g., device door actuator 631 in FIG. 2A). Sensor apparatus(es) include temperature sensors, pressure sensors, humidity sensors, thermostats and other condition monitoring apparatus(es). (See, e.g., fire extinguisher pressure sensor 601 in FIG. 2A). This category would include apparatus to monitor the condition and operability of emergency equipment such as fire extinguishers (as illustrated in FIG. 2A). Further, as noted, a variety of other system control apparatus(es) such as pressure valves, thermostats and environmental controls can be easily monitored and controlled using the technology of this invention. And, all of the aforesaid operations and monitoring can be accessed, tracked and/or controlled using the various methods and techniques of the invention described herein. Thus, as illustrated in FIGS. 2A and 2B, a remote user can, e.g., accomplish the foregoing via cell phone 501, laptop computer 503, and pager 502, by wireless signal 402 conveyed to internet 401 from anywhere within the reach of a cellular tower.

The FIG. 2B provides another exemplary application of our invention, here using an effectuator 200 to monitor a group of fire extinguisher pressure sensors 601 via a Zigbee Network 612. The fire extinguisher pressure sensors 601 are configured so that they are Zigbee routers as well as end points. Thus, in this configuration the network traffic may move from fire extinguisher pressure sensor to fire extinguisher pressure sensor 601 until the final network hop to the effectuator 200. The effectuator 200 will then store and forward the readings of the extinguisher pressure sensors 601 on request or by event to, in the example given, a managing computer 101 via internet 401. Further, though FIG. 2B depicts a single effectuator 200 and Zigbee Network 612, the system can be scaled upward to include a plurality of effectuators 200 and Zigbee Networks 612. The advantages of this system architecture are manifold. First, Zigbee devices such as the fire extinguisher pressure sensors 601 create a low power battery operated wireless mesh network, the Zigbee Network 612. Second, there is no need for other network components to create the Zigbee Network 612. Third, a single effectuator 200 functions as a gateway device to the ubiquitous internet 401, for monitoring all of the fire extinguisher pressure sensors 601. Fourth, the system is easily scaleable.

In sum, returning to FIG. 1C, effectuator 200 allows monitoring of various sensor devices 600 and 610, and applying program logic to determine appropriate action to be taken via control apparatuses 620 and 630. It receives commands from and can communicate the occurrence of events to a remote managing computer 100 and/or to a remote web enabled device 500. In addition, communication may take place between an effectuator 200 and a remote web enabled device 500 via a managing computer 100. However, the simplest possible architecture is a remote web enabled device 500 communicating to an effectuator 200. It should be emphasized at this point that this simple architecture is very powerful allowing a user with a remote web enabled device 500, without additional software other than firmware residing in web server 251, to monitor and control an effectuator 200. It should also be remembered that effectuator(s) 200 are designed to operate without any connectivity to a managing computer 100 or other remote web enabled device 500. The necessary operational program and data store resides in the web server 251 memory of effectuator 200.

Thus, a remote network enabled device 500 or managing computer 100 can access a main interface page like that illustrated in FIG. 11A, which provides an exemplary screen shot illustrating a basic information and monitoring page produced by the firmware of the invention. From this page one can, e.g., go directly to any of the pages illustrated in FIGS. 11B through 11F. FIG. 11B is a status page produced when “users” on the status page illustrated in 11A is clicked. It provides a list of authorized users for effectuators and/or apparatus(es). This list of users and/or the conditions governing their use(s) can be changed by an administrator having necessary authorization. FIG. 11C is a status page produced when “groups” on the status page illustrated in 11A is clicked. It provides a list of authorized groups of users. This list of groups and/or the conditions governing their use(s) can likewise be changed by an administrator having necessary authorization. FIG. 11D is a status page produced when “keys” on the status page illustrated in 11A is clicked. It provides further status and re-programming opportunities related to apparatus(es) monitored by an effectuator 200 (in this case, keys in a keybox). FIG. 11E is a status page produced when “rules” on the status page illustrated in 11A is clicked. It provides a screen for writing and re-writing rules related to apparatus(es). FIG. 11F is a status page produced by the firmware of the invention when “panel” is clicked. It provides network status and re-programming opportunities related to configuration, alarm timer, hardware configuration and other information. In addition, exemplary base page 11A shows a virtual keypad for inputting a PIN, color coded alarm status information, panel status (i.e., operational status), key (i.e., apparatus status), and a panel transaction log.

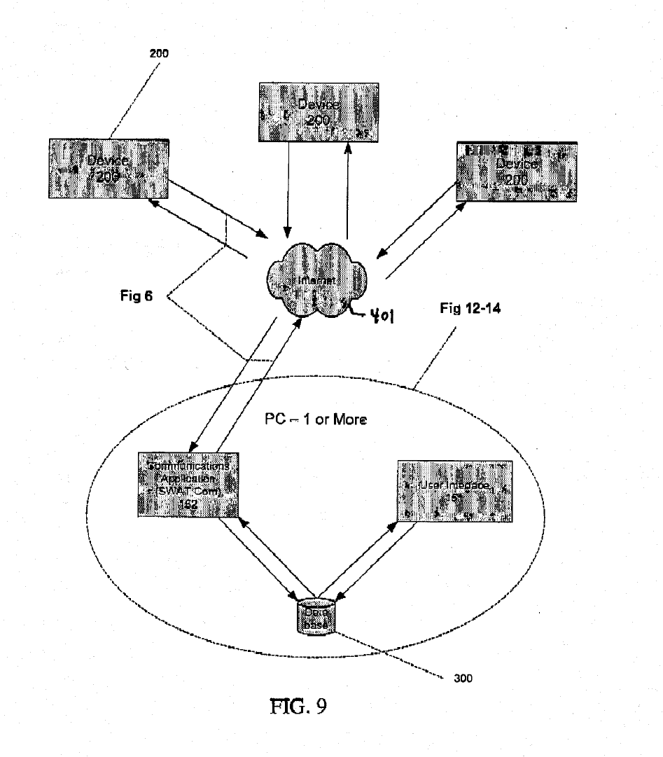

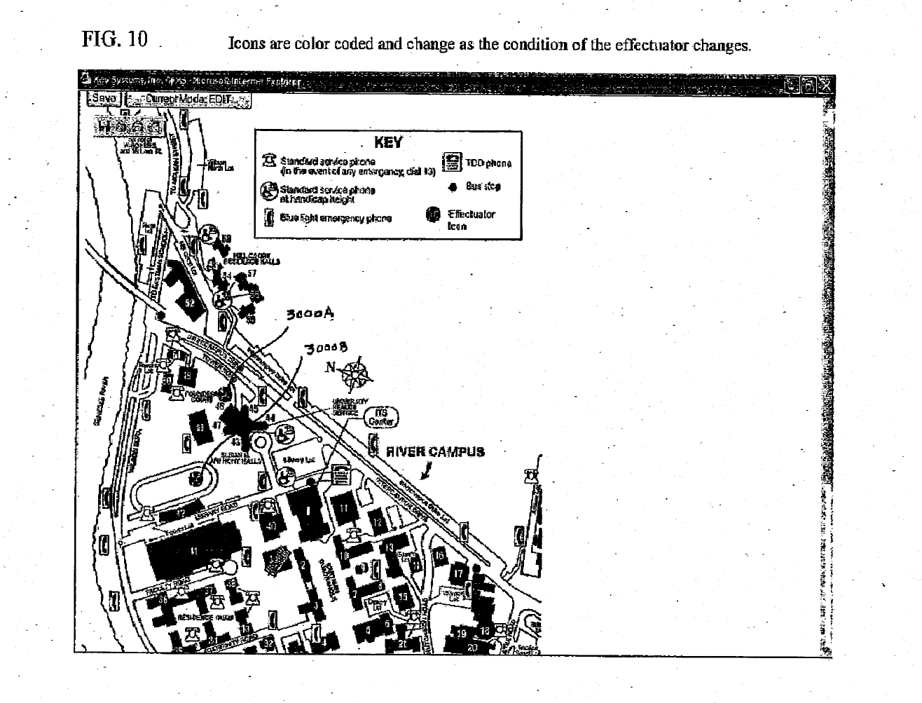

In view of the foregoing (and as previously noted), the firmware of server 251 allows extensive programming and/or reprogramming of system effectuator(s) 200 via any type of remote network enabled devices 500. However, the system may advantageously include a computer-based software loaded on managing computer(s) 100 capable of interacting with the XML interface 252 of effectuator(s) 200. This allows the effectuator 200 to be completely reprogrammed and/or upgraded as to its operating firmware via the communications medium (network 400). Managing computer(s) 100 also facilitate and allow monitoring and control of systems including many effectuators 200. (See, FIGS. 9 and 10). Thus, in system implementations where many users and effectuators 200 are present the managing computer 100 software application allows consolidated monitoring and control.

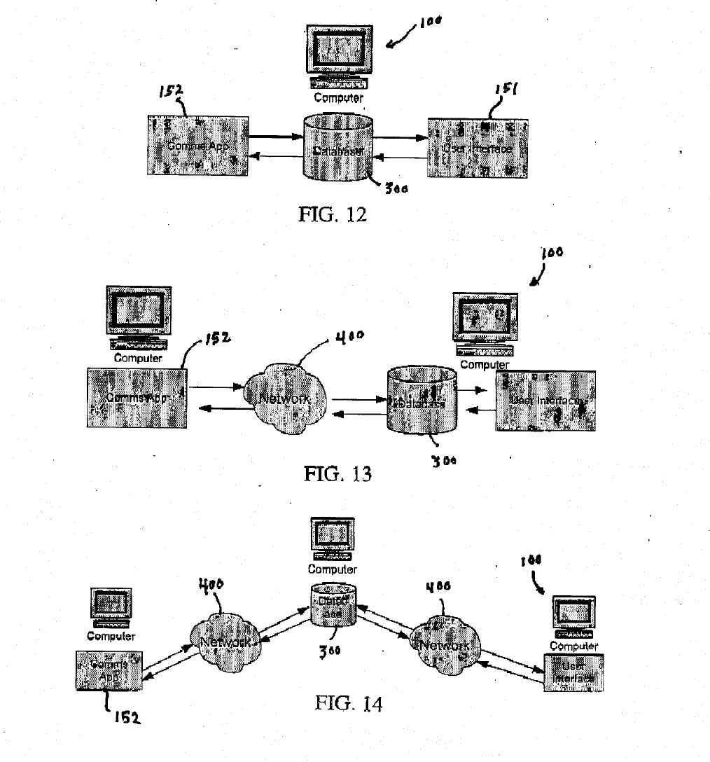

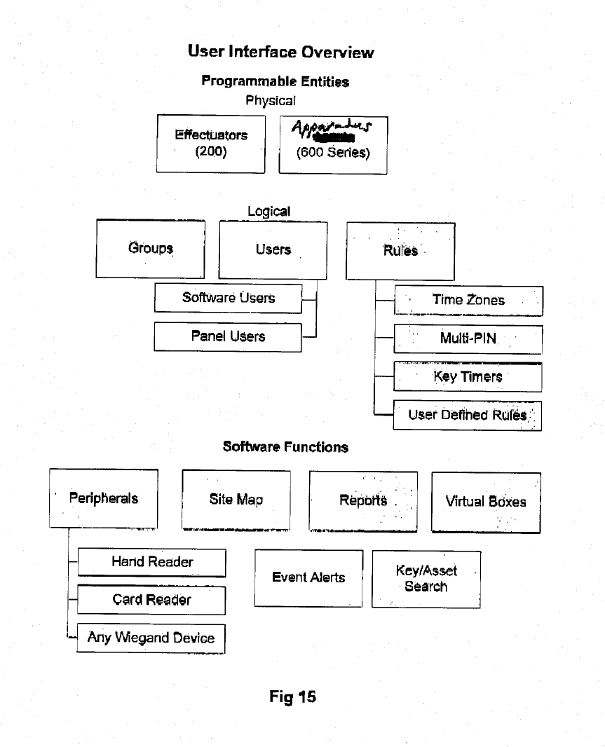

In addition, the managing computer 100 has the capability to communicate to a locally resident or remote database device 300. This, as well as communications on behalf of managing computer 100 (using communicator 152) with an effectuator 200 can take several forms. Thus, as illustrated in FIG. 12, the database software application (database 300), communications software application (communicator 152), and user interface or managing software application (which interfaces with and is referenced along with web server software 151) are all running on the same PC. In FIG. 13 the database 300 and managing computer software application 151 are both running on the same PC, and the communicator 152 is running on a different PC. And, in FIG. 14 database 300, communicator 152, and user interface software application 151 are all running on different PCs. However, wherever located, the database device 300, will store all effectuator 200 commands, event information, and system configuration information. The managing computer 100, interacting with database device 300, is able to generate detailed reports allowing users of the system to closely review the system operation for any abnormalities.

Further, the general system architecture shown in FIG. 1C is designed to provide real time information and access to local and remote users that are concerned with the various operating aspects of an effectuator 200 or system of effectuators 200. The technology used to implement the specifics of the system allow for maximum scalability, maintainability and accessibility. Scalability is achieved by allowing additional devices 100, 200 300, 500, 600, 610, 620 and 630 to be added to the system meeting increased operational demand. Ease of maintainability is accomplished by dividing the system functionality amongst easily replaceable components. Local and remote accessibility is inherent in all the devices based on their built-in capability to access network 400.

In addition, as the foregoing makes clear, the system and firmware of the invention provide full programming control of the effectuator 200 to a user via a remote network enabled device 500 with no external device software required other than a web browser. Thus, using a remote web enabled device 500 alone, effectuator 200 can (among other things) be reset to factory settings, receive a new operation program over the network 400 or through an RS232 interface, be instructed to reprogram itself with a new or upgraded operational program, report memory consumption, provide a warning when memory is running low, automatically contact managing computer 100 or an other remote network enabled device 500 to download transaction history, automatically message a user by email or otherwise, convey the condition of assets, convey information related to the operation and viability of effectuator(s) 200 and apparatus(es) 600, 610, 620, 630, release assets remotely (via PCs, phones, and other remote network enabled devices 500) and via direct connections, have PINs usable once and then roll to the next programmed PIN to prevent re-entry, and/or provide an interpreter/converter to allow the effectuator 200 to interpret various formats of Wiegand protocols.

As an explanatory matter, Weigand protocols are input/output protocols for dealing with external identification devices such as magnetic cards, dealing with biometric identification criteria, and so forth. The Weigand interface 253 of effectuator 200 allows the managing computer 100 and the effectuator 200 to use only the portion of a Wiegand string that applies to the unique identifier of the user. It also allows for sections of the Wiegand string to be combined by various logical operators to obtain the proper grouping of the binary digits to represent the unique user identifier. The interface 253 provides a way to ignore sections associated with such things as site codes.

The firmware of the invention also allows creation of a transaction log of all events that have occurred at an effectuator 200, creation of a log of all the programming actions for the effectuator 200 (including the time of each action, and the users responsible for the actions), and creation of a CRC check sum field in each transaction record based in an effectuator 200 that totals all the field contents of the current record with all the field contents of the previous record in order to prevent tampering with the data. The last mentioned aspect of the invention involves the use of CRC check sums in the database 300 to create a check sum field in each record that totals all the field contents of the current record, with all the field contents of the previous record, to prevent tampering with the database 300.

Further, the system and firmware of the invention facilitate enrolling users (who are authorized to access the system and effectuator(s) 200) by making provision for enrolling same and assigning them personal identification numbers (PINs), assigning other identification criteria (such as biometric criteria, magnetic cards, etc.), enrolling users into job descriptions or groups, setting user audit dates that alert the administrator to review particular user(s), enrolling assets that are to be controlled, assigning assets directly to authorized asset users, enrolling assets into one or more groups, creating time zones (within or outside of which) certain actions are allowed to happen, establishing expiration logic (or the ability to set up a user PIN that will expire on a specified date and time), and very advanced rule making capabilities related to control and monitoring of apparatus(es) 600, 610, 620, 630.

Other preferred features of the web server 251 based firmware of the invention are illustrated generally in FIG. 3. As illustrated in this figure, the firmware of the invention can advantageously include a product application layer 251A interacting with a common application elements layer 251B, which interacts with an application services layer 251C, which interacts with a communication services layer 251D, which interacts with an OS, which interacts with a communication and hardware interface layer, which interacts with a hardware layer 251F, with a Rules Engine 1000 residing in application services layer 251C. In reviewing the advanced rule making capabilities referenced above (and denoted as Rules Engine 1000 in FIG. 3), it should first be noted that previous asset control systems utilized fixed non-changeable rules built into the application software at compile time. Hence, if a customer wanted additional or different rules governing the operation of the asset control system, the asset control system provider would have had to build those customer rules into the application prior to sale. As the number of customers and the number of rules increase, the ability to satisfy customer requirements diminishes. The prior art failed to provide an efficient method for managing this customer requirement. The prior art method of building rules into the application proved time consuming because the asset control system provider had to expend time to build and release a new application. This method also proved inflexible because a customer could not create a new, unique rule without the involvement of the asset control system provider.

In contrast to prior art methods, the advanced rule making capabilities of the firmware 251 of our invention are designed to allow customers to create the rules governing the operation of the asset control system with ease and flexibility. The rules are created at runtime rather than at compile time, which was a prior art restriction. The new art allows the creation of new and unique rules without the involvement of the asset control system provider. Hence, the asset control system provider does not need to provide new application software for new functionality. The new art allows customers the flexibility to create new and unique rules that in the prior art would have had to be compiled into the application firmware at its creation.

The Rule Engine design consists of 3 sub-systems: (1) Rule generation user interface software 1001, (2) Rule parser and compiler 1002, (3) Rule execution engine 1003. (See, FIG. 4). The Rule generation user interface software consists of a set of computer screens and forms that allow the user to add, edit or delete a rule. The Rule parser and compiler receive the Rule string and transform the string into a format that is most efficient for the Rules execution engine. The Rules execution engine is responsible for execution of the Rule.

Rules are created by the customer at runtime using the user interface software 1001, which is then parsed and compiled for execution by the Rule execution engine 1003. A Rule consists of a Rule name, Rule condition, Rule action false, and Rule action true statements. Any entity associated with apparatus(es) 600, 610, 620, 630 controlled/monitored by an effectuator 200 may have an associated Rule. (In this context, “entity” is used to designate a user, group, asset, or other item/criteria/person or other matter associated with usage of the effectuator 200 and/or apparatus(es) 600, 610, 620, and 630). The associated entity Rule is typically, but not necessarily, exclusively executed when the entity is involved in a transaction. For example, if user A in group B desires asset C from an asset dispensing apparatus, then an associated rule could be executed for any or all A, B, and C entities, depending on what entities had associated rules.

A Rule minimally must have a Rule name and one Rule action. In most Rules, a condition statement will also be included. Thus, using conversational language constructs, a rule could be stated as: If the user is “John” and John belongs to group “Security,” and the current time is between 10a and 2p, then release assets 1, 2 and 3; otherwise, do nothing. Rules can be chained together to allow for a richer set of rule creation options and intermediate actions. Also, by allowing Rules to be chained, Rule re-use is possible. Hence, a common Rule may be shared by other Rules, saving valuable memory space on the device and simplifying Rule creation. Historically, in asset control systems, it has been difficult to foresee and implement all customer asset control requirements in advance. Fixed compile time rules are deficient for addressing customer needs. Using our new art Rule design, customers can now create, save, edit and delete rules at runtime.

In addition, our method of allowing one or more authorized device managers to interface with the effectuator 200 through other remote web-enabled devices (e.g., cell phones 501, laptops 503, and pagers 502) allows the creation of a list of job descriptions to automatically set up user authority levels. The top of the list indicates a high authority job and the bottom of the list a low authority job. This list allows the inserting or deleting of a new description which will adjust the authority levels accordingly. This makes it easy for the user to correctly set authority levels instead of converting everyone to a number reference for authority. Most people understand what job title is more important than another within their businesses. The software then uses the position of the description in the list as the basis of rules to control operations of the device. Such rules specify the need of certain authority level personnel to be present (known by the entry of their personal identification) for the use of assets.

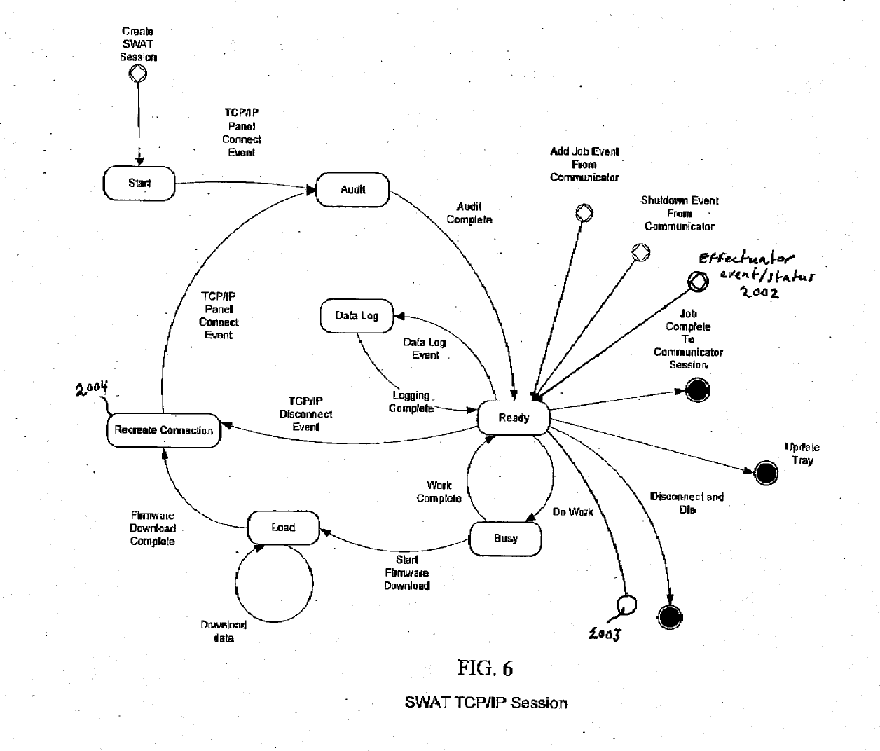

The communications aspects of the invention are best understood by reference to the communicator 152 referenced in FIG. 1 and also with reference to FIGS. 5A, 5B, 6 and 7. In terms of communications engineering, we use software that runs as a Microsoft Windows Service. This provides a main session with configurable options (to be started automatically upon computer startup, or to be started manually via the Microsoft services interface). In addition, it provides a main session to request a queue 2001 looking for commands to process, to capture events 2002 from web servers 251, and to verify windows checksums of the data sent from the effectuator(s) 200 received by the network controller of network computer 100 (the windows checksums are then verified again as the data is written onto database 300 before an acknowledgement is given to the effectuator(s) 200 to move on to the next record). (See, 2003 of FIG. 6).

Further, this main session creates connections to the database 300 log based on system-configured alarm level; to the console if service started in debug mode based on the debug level; and to the database 300 (to update status, too update effectuator 200 and apparatus hardware status, to update effectuator 200 and apparatus alarm status, and to upload effectuator 200 logs). And, it is used to create TCP/IP client sessions with effectuator(s) 200 upon service start, to create TCP/IP client sessions for effectuators 200 added to the system, and to destroy TCP/IP client sessions for effectuators 200 removed from the system. (See, generally, FIG. 6).

As illustrated in the example given in FIG. 6, the use of software that runs as a Microsoft Windows Service also provides concurrent TCP/IP client sessions to handle a variety of issues, such as: to handle XML interface with effectuator(s) 200; to perform effectuator 200 audits; to perform effectuator 200 alarm audits; to decode and handle events from the effectuator 200; and to provide data to managing computer 100 concerning effectuator(s) 200 (such as status, alarm status, and hardware status). Concurrent TCP/IP client sessions also allow our invention to provide date and time synchronization between the managing computer 100 and effectuator(s) 200; to download effectuator(s) 200 firmware; to download effectuator(s) 200 configuration; to download effectuator(s) 200 user information; to download effectuator(s) 200 group information; to send effectuator(s) 200 commands; to receive effectuator(s) 200 command replies; to provide a “heartbeat” message to effectuator(s) 200; to reconnect to effectuator(s) 200 if the TCP/IP connection is lost (in that case, the heartbeat times out); and to reconnect to effectuator(s) 200 if the “heartbeat” reply is not received in the configured time (see, 2004 of FIG. 6).

The communication between the effectuator(s) 200 and the communicator 152 is optionally authenticated and encrypted. If authentication is required then the Communicator 152 must provide a password to effectuator(s) 200 to establish communications. Additionally, the password may be encrypted. Once the communication channel has been established all the data or just sensitive portions may be encrypted. The encryption algorithms make use of a shared key that changes with every connection. The dynamic nature of the shared key adds another layer of complexity when trying to break the encryption algorithm.

Additional details related to preferred forms and features of the remote managing computer 100 based software of the invention are best understood in relation to FIGS. 8A, 8B, 9, 10 and 11A. As with other web enabled devices 500, the preferred embodiment of the invention's firmware allows the effectuator 200 to be completely reprogrammed or upgraded by a remote managing computer 100 via the communications method either by a user directly (see, FIG. 8A) or by inputting the customer's personal data base (see, FIG. 8B). The software of remote managing computer 100 is also capable of presenting a map of all effectuator(s) 200 and/or apparatuses 600, 610, 620, 630 that are part of the system (as illustrated in FIG. 10) with representative icons 3000A and 3000B on the map that show the location of each effectuator 200 and/or apparatus 600, 610, 620, 630 as well as its state (such as whether it is connected, alarmed, date and time of transaction, etc.). The state can preferably be shown by a feature of an icon 3000A, 3000B. (In the example given the icons 3000A, 3000B are different colors with 3000A being green to show it is connected and conditions are optimal, and 3000B being red to show it is connected and an active alarm. An icon 3000A, 3000B can also be gey to show it is disconnected or yellow where it has had an active alarm and that alarm has been acknowledged by the user. In addition, the software allows icon 3000A, 3000B single-click connection directly to the icon apparatus' effectuator 200 web server 251 interface for more details (as illustrated in FIG. 11A). Further, though the representative example provided in FIGS. 10 and 11 shows only a single map (FIG. 10) with icon click to web page (FIG. 11) providing detailed status related to an effectuator 200 and/or its apparatus(es) 600, 610, 620, 630 via its web server 251, maps can be easily layered. Thus, a map of an area with icons 3000 can be clicked to bring up a map with buildings having representative icons, which can be clicked to bring up room lay-out with icons which can also be clicked. Thus, the foregoing “drill-down” methodology can be adapted as necessary or desirable to meet the needs and requirements of particular situations and users.

In addition, the software or managing computer 100 provides a communication interface to talk to effectuator(s) 200 as previously described with respect to FIG. 5 (where an event at a SWAT box incorporating an effectuator 200 triggers communications), provides a programming interface that allows programming of one or more effectuator(s) 200 with all the programming options previously outlined, the propagating of an effectuator 200's programming to other programmers, assigns effectuators 200 to groups, allows the enrollment of persons authorized to use the software in the managing computer 100, allows those authorized to be limited in controlling certain groups in the assigned controller groups (i.e., hierarchies of authority can be easily established where some users have authority to control the authority/access of other users), and allows networking and multi-user operation of the software of the managing computer 100. Further, it tracks and records into database 300 all actions by any user of this software, backs up all of the programming information in the effectuator(s) 200, allows changes to the programming of effectuators 200, creates a PC database 300 of all programming and transaction data, and provides various reports from the database 300 of the programming and transaction data.

Preferred forms and features of the electrical components of the invention are best understood in relation to FIGS. 17, 18 and 19, where these features are schematically illustrated in relation of SWAT box 201 type effectuator/apparatus. The electrical components and design of the invention are characterized by the use of the new Power Over Ethernet (POE) Standard for multipurpose effectuator(s) 200, provision for interfacing with various types of apparatuses 600, 610, 620, and 630, provision for increasing the amount of I/O (inputs/outputs), provision for increasing the amount of on-board memory to grow with I/O or customer requirements, and provision for removable/replaceable memory for safekeeping of data.

The use of the POE standard provides current for the charging of effectuator 200 internal batteries; and requires only one Ethernet standard cable 202 for communications and power to the effectuator 200 and/or apparatus(es) 600, 610, 620, and 630. (The multipurpose effectuator 200 of our invention also has low power consumption through the ability to put various functions to “sleep”, an RS232 bus for programming and communications, and an RS485 bus for communications to sub-controllers, displays, and ID input devices. The last item mentioned includes sub-controllers that can collect various types of data input such as but not limited to presence and inventory detection. This can be accomplished by methods such as physical sensing (based on switch sensing, weight sensing, and light sensing), through radio frequency tag (RFID) sensing (by attaching an RFID tag to the physical device), and Dallas Semiconductors touch memory tag sensing. With respect to touch memory tag sensing, the tags can be located across the system of network cabinets, they can be returned to any cabinet and taken from any cabinet, and they can take a “key fob” design. As to “key fob” design, this can include: A phone jack designed “Key Fob” to allow multiple conductors to connect to the chip in the cap of the key fob; and a light pipe cap on each key fob that glows from the light of the LED and allows the illumination to be seen from any angle and through the cluster of keys and key rings that can develop in a heavily packed cabinet.

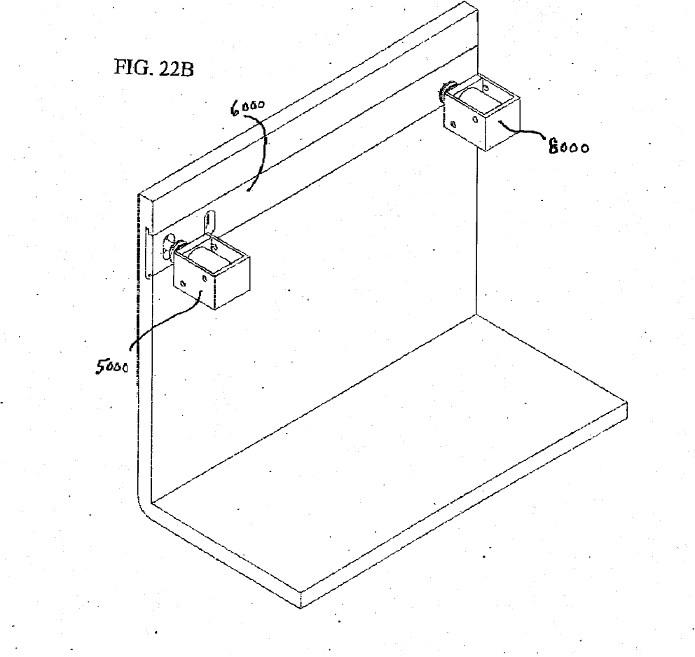

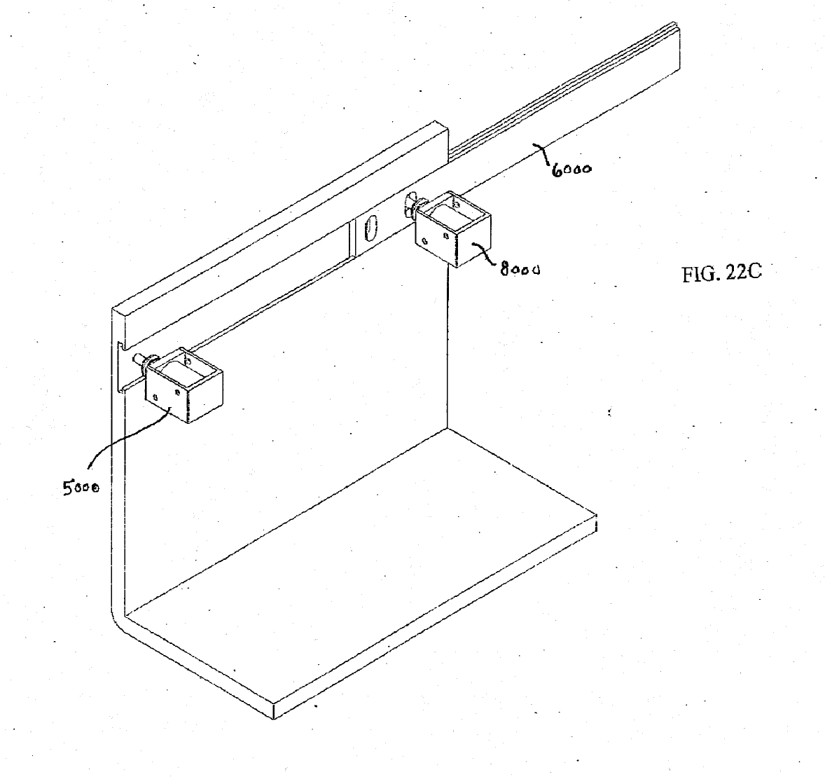

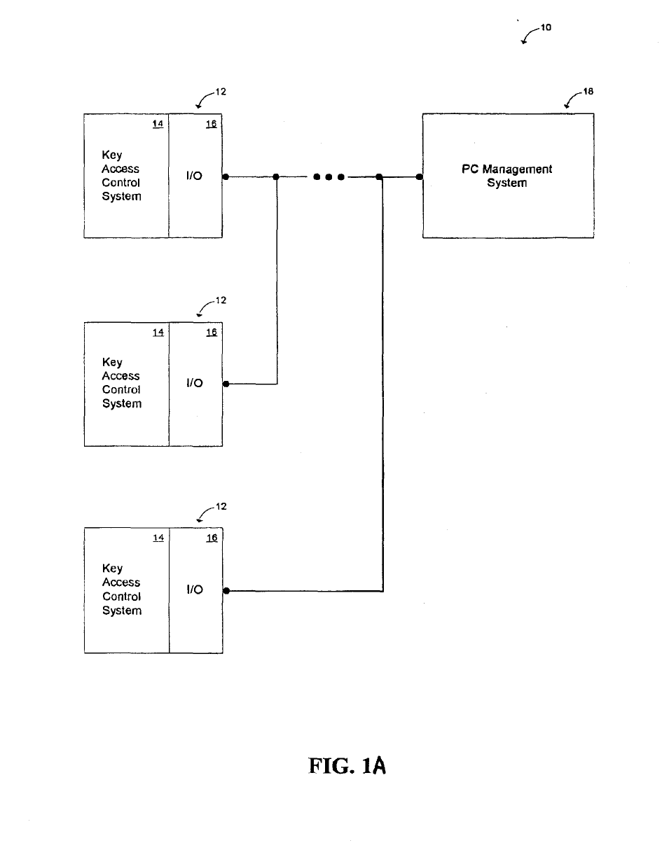

The preferred physical forms and features of a particular effectuator 200 served apparatus of the invention (a “SWAT BOX”) is best understood in relation to FIGS. 20A through 21D. The mechanical components and design of this preferred embodiment of the invention are characterized by (a) the use of an emergency solenoid 5000 to provide the emergency backup release to open the device, and (b) the use of a slide in detent bracket. The emergency solenoid 5000, when powered, pulls out the pivot pin 5000A of the retaining latch 6000 allowing the latch 6000 to come apart, thereby releasing the door/drawer 7000 of this embodiment. (See, e.g., FIGS. 20A through 20F). Thus, in a first preferred embodiment a latch of said lockbox has a latch member 6000 for latching a lock box opening and a pivot connection end whereby it is pivotally connected to the lock box via the emergency solenoid 5000, which pivot connection pin is a solenoid pin (of the emergency release solenoid 5000) that can be withdrawn to release the latch member 6000 from its connection to the lock box and allow opening of the lockbox. More generally, it can be said that there is a latch member 6000 for latching a lock box opening member closed, which latch member 6000 has a lock box frame connection portion whereby it is connected to the lock box frame via a solenoid pin 5000A that can be withdrawn to release the latch member from its connection to the lock box and allow opening of the lockbox. (See, e.g., FIGS. 22A through 22C, where a retaining (emergency release) solenoid 5000 attached to the frame can release a latch member 6000 that a latching solenoid 8000 attached to the lock box opening member engages to lock the lock box). The emergency release solenoid can be powered by an independent control system and can be wired to a remote access point where a temporary power source can be applied.

The slide in detent bracket acts to control and protect the wire communication/power cable loop, providing sufficient length to allow the sliding drawer to open with this wire connected to the sliding drawer. (See, FIGS. 21A through 21C). It also acts as an extension limit to the drawer to prevent the drawer from being pulled out, as a security device to prevent easy access to the mechanism when the drawer is opened, and to allow service to the mechanism without the physical removal of the outer casing from the wall.

The foregoing description of certain features of our invention is not intended to be exhaustive. As the disclosure makes clear, there are numerous other aspects and possibilities inherent in the invention that are not covered by the aforesaid description. Moreover, numerous changes and variations are possible without exceeding the scope of the inventive concept. Accordingly, it is to be understood that the embodiments of the invention herein described are merely illustrative of the application of the principles of the invention. Reference herein to details of the illustrated embodiments is not intended to limit the scope of the invention claimed.

What is claimed is:

1. A system for monitoring and/or control, comprising: at least one system effectuator for at least one of monitoring and controlling an apparatus, said at least one system effectuator including a server system coupled to a communications medium, wherein the server system is capable of storing programs related to operations of the at least one system effectuator and allows the at least one system effectuator to be accessed remotely via said communications medium.

2. The system of claim 1, further comprising at least one remote device capable of accessing said at least one system effectuator via the communications medium and the server system so as to at least one of: monitor and control said apparatus via said effectuator.

3. A system as described in claim 1, wherein said server system includes server based firmware allowing at least one of programming and reprogramming of the system effectuator via an at least one remote device.

4. A system as described in claim 1, wherein said communications medium is a network.

5. A system as described in claim 1, wherein said communications medium is at least one of: internet, intranet, direct connection, ethernet connection, and phone connection.

6. A system as described in claim 2, wherein said at least one remote device capable of accessing said at least one system effectuator is at least one of a: computer, PDA, telephone, pager, and kiosk.

7. A system as described in claim 2, wherein said at least one effectuator further includes an XML interface, which XML interface at least one of: facilitates transfer of information in the at least one effectuator to said at least one remote device, and facilitates programming of the at least one effectuator by the at least one remote device.

8. A system as described in claim 2, further including software of a remote device for at least one of programming and reprogramming at least one of said firmware and said effectuator.

9. A system as described in claim 7, further including software of a remote device for at least one of programming and reprogramming at least one of said firmware and said effectuator.

10. A system as described in claim 1, wherein said apparatus is at least one of: an access control apparatus, a sensor apparatus, and a system control apparatus.

11. A system as described in claim 10, wherein any such access control apparatus is an ingress/egress control apparatus.

12. A system as described in claim 7, further including a database, which database stores at least one of: effectuator event information, effectuator command information, and system configuration information.

13. A system as described in claim 8, further including a database, which database stores at least one of: effectuator event information, effectuator command information, and system configuration information.

14. A system as described in claim 9, further including a database, which database stores at least one of: effectuator event information, effectuator command information, and system configuration information.

15. A system as described in claim 3, wherein said firmware allows the said at least one remote device to interact with said at least one effectuator to at least one of: reprogram said at least one effectuator, obtain status reports and warnings related to operations of at least one of an effectuator and an apparatus, download transaction history related to at least one of an effectuator and an apparatus, establish or change user access criteria, and make and change rules related to an apparatus.

16. A system as described in claim 3, wherein said firmware allows a user to write or re-write rules governing operation of an apparatus of the at least one effectuator via a rules engine.

17. A system as described in claim 16, wherein said rules engine comprises at least one of a rule generation user interface, a rule parser and compiler, and a rule execution engine.

18. A system as described in claim 17, wherein any said rule generation user interface generates computer screens and forms that allow a user to add, edit or delete a rule.

19. A system as described in claim 17, wherein any said rule parser and compiler can receive a rule string and transform the string into a format that is most efficient for the rules execution engine.

20. A system as described in claim 17, wherein any said rules execution engine is responsible for execution of the rule.

21. A system as described in claim 17, wherein rules can be written or re-written by a user of the effectuator at runtime.

22. A system as described in claim 16, wherein a rule includes a rule name and a rule action and can also include at least one of a rule condition, rule action false, and rule action true statements.

23. A system as described in claim 16, wherein a common rule may be shared by other rules.

24. A system as described in claim 8, wherein said software enables a user at the remote device to at least one of: perform effectuator asset audits, perform effectuator alarm audits, monitor and respond to events from an at least one effectuator, and obtain data from an effectuator related to at least one of asset status, alarm status, and hardware status.

25. A system as described in claim 8, wherein some portion of communication between an at least one effectuator and the at least one remote device can be at least one of password authenticated and encrypted.

26. A system as described in claim 25, wherein any such password can also be encrypted.

27. A system as described in claim 25, wherein encryption algorithms make use of a shared key that changes with each connection between the at least one effectuator and the at least one remote device.

28. A system as described in claim 1, wherein the system maintains live connection between the at least one effectuator and the at least one remote device with real-time command/event processing instead of polling.

29. A system as described in claim 8, wherein said software is capable of managing a plurality of effectuators.

30. A system as described in claim 29, wherein said software is capable of presenting maps of all effectuators that are part of the system, with representative icons on the maps that show where at least one of an effectuator and an apparatus is located.

31. A system as described in claim 30, wherein clicking on an icon on a map will produce at least one of a more localized map with icons, and a status screen displaying status of at least one of an effectuator and an apparatus at the icon location on the last map produced.

32. A system as described in claim 30, where a characteristic of an icon indicates status of at least one of an effectuator and an apparatus.

33. A system as described in claim 32, where said characteristic is icon color.

34. A system as described in claim 13, wherein CRC checksums are used in relation to the database to create a check sum field in each record that compares all the field contents of the current record with all the field contents of the previous record to prevent tampering with the database.

35. A system as described in claim 1, wherein said at least one effectuator is supplied with power via a Power Over Ethernet (POE) standard cable.

36. A system as described in claim 1, wherein ethernet cable is used for both communications and to provide power to at least one of the at least one effectuator and the at least one apparatus.

37. A system as described in claim 1, wherein said at least one apparatuses includes a lockbox, which lock box uses a solenoid pin as an emergency release mechanism.

38. A system as described in claim 37, wherein a said lockbox has a latch member for latching a lock box opening member closed, said latch member has a lock box frame connection portion whereby it is connected to the lock box frame via a solenoid pin that can be withdrawn to release the latch member from its connection to the lock box and allow opening of the lockbox.

39. A system for monitoring and/or control, comprising:
a) at least one system effectuator for at least one of monitoring and controlling an apparatus, said at least one system effectuator including a server system coupled to a communications medium, wherein the server system is capable of storing programs related to operations of the at least one system effectuator and allows the at least one system effectuator to be accessed remotely via said communications medium;
b) at least one remote device capable of accessing said at least one system effectuator via the communications medium and the server system so as to at least one of: monitor and control said apparatus via said effectuator;
c) wherein said server system includes server based firmware allowing at least one of programming and reprogramming of the system effectuator via said at least one remote device; and
d) wherein said apparatus is at least one of: an access control apparatus, a sensor apparatus, and a system control apparatus.

40. A system as described in claim 39, wherein said communications medium is a network.

41. A system as described in claim 39, wherein said communications medium is at least one of: internet, intranet, direct connection, ethernet connection, and phone connection.

42. A system as described in claim 39, wherein said at least one remote device capable of accessing said at least one system effectuator is at least one of a: computer, PDA, telephone, pager, and kiosk.

43. A system as described in claim 39, wherein said at least one effectuator further includes an XML interface, which XML interface at least one of: facilitates transfer of information in the at least one effectuator to said at least one remote device, and facilitates programming of the at least one effectuator by the at least one remote device.

44. A system as described in claim 43, further including software of a remote device for at least one of programming and reprogramming at least one of said firmware and said effectuator.

45. A system as described in claim 39, wherein any such access control apparatus is an ingress/egress control apparatus.

46. A system as described in claim 44, further including a database, which database stores at least one of: effectuator event information, effectuator command information, and system configuration information.

47. A system as described in claim 39, wherein said firmware allows the said at least one remote device to interact with said at least one effectuator to at least one of: reprogram said at least one effectuator, obtain status reports and warnings related to operations of at least one of an effectuator and an apparatus, download transaction history related to at least one of an effectuator and an apparatus, establish or change user access criteria, and make and change rules related to an apparatus.

48. A system as described in claim 39, wherein said firmware allows a user to write or re-write rules governing operation of an apparatus of the at least one effectuator via a rules engine.

49. A system as described in claim 48, wherein said rules engine comprises:
at least one of a rule generation user interface, a rule parser and compiler, and a rule execution engine;
wherein any said rule generation user interface generates computer screens and forms that allow a user to add, edit or delete a rule;
wherein any said rule parser and compiler can receive a rule string and transform the string into a format that is most efficient for the rules execution engine; and
wherein any said rules execution engine is responsible for execution of the rule.

50. A system as described in claim 48, wherein rules can be written or re-written by a user of the effectuator at runtime.

51. A system as described in claim 48, wherein a common rule may be shared by other rules.

52. A system as described in claim 44, wherein said software enables a user at the remote device to at least one of: perform effectuator asset audits, perform effectuator alarm audits, monitor and respond to events from an at least one effectuator, and obtain data from an effectuator related to at least one of asset status, alarm status, and hardware status.

53. A system as described in claim 39, wherein some portion of communication between an at least one effectuator and the at least one remote device can be at least one of password authenticated and encrypted.

54. A system as described in claim 53, wherein any such password can also be encrypted.

55. A system as described in claim 53, wherein encryption algorithms make use of a shared key that changes with each connection between the at least one effectuator and the at least one remote device.

56. A system as described in claim 39, wherein the system maintains live connection between the at least one effectuator and the at least one remote device with real-time command/event processing instead of polling.

57. A system as described in claim 44, wherein said software is capable of presenting maps of all effectuators that are part of the system, with representative icons on the maps that show where at least one of an effectuator and an apparatus is located, and wherein clicking on an icon on a map will produce at least one of a more localized map with icons, and a status screen displaying status of at least one of an effectuator and an apparatus at the icon location on the last map produced.

58. A system as described in claim 57, where a characteristic of an icon indicates status of at least one of an effectuator and an apparatus.

9. A system as described in claim 46, wherein CRC checksums are used in relation to the database to create a check sum field in each record that compares all the field contents of the current record with all the field contents of the previous record to prevent tampering with the database.

60. A system as described in claim 1, wherein an effectuator is supplied with power via a Power Over Ethernet (POE) standard cable and wherein said cable is used for both communications and to provide power to at least one of the effectuator and an apparatus.

61. A system as described in claim 39, wherein a said lockbox has a latch member for latching a lock box opening member closed, said latch member has a lock box frame connection portion whereby it is connected to the lock box frame via a solenoid pin that can be withdrawn to release the latch member from its connection to the lock box and allow opening of the lockbox.

62. A system for monitoring and/or control, comprising:
a) at least one system effectuator for at least one of monitoring and controlling an apparatus, said at least one system effectuator including a server system coupled to a communications medium, wherein the server system is capable of storing programs related to operations of the at least one system effectuator and allows the at least one system effectuator to be accessed remotely via said communications medium;
b) at least one remote device capable of accessing said at least one system effectuator via the communications medium and the server system so as to at least one of: monitor and control said apparatus via said effectuator;
c) wherein said server system includes server based firmware allowing at least one of programming and reprogramming of the system effectuator via said at least one remote device; and
d) wherein said apparatus is at least one of: an access control apparatus, a sensor apparatus, and a system control apparatus; and
e) wherein at least one effectuator is supplied with power via a Power Over Ethernet (POE) standard cable and said cable is used for both communications and to provide power to at least one of the effectuator and an apparatus.

63. A system as described in claim 62, wherein said communications medium is a network.

64. A system as described in claim 63, wherein said at least one remote device capable of accessing said at least one system effectuator is at least one of a: computer, PDA, telephone, pager, and kiosk.

65. A system as described in claim 64, wherein said at least one effectuator further includes an XML interface, which XML interface at least one of: facilitates transfer of information in the at least one effectuator to said at least one remote device, and facilitates programming of the at least one effectuator by the at least one remote device.

66. A system as described in claim 65, further including software of a remote device for at least one of programming and reprogramming at least one of said firmware and said effectuator.

67. A system as described in claim 66, wherein any such access control apparatus is an ingress/egress control apparatus.

68. A system as described in claim 67, further including a database, which database stores at least one of: effectuator event information, effectuator command information, and system configuration information.

69. A system as described in claim 68, wherein said firmware allows the said at least one remote device to interact with said at least one effectuator to at least one of: reprogram said at least one effectuator, obtain status reports and warnings related to operations of at least one of an effectuator and an apparatus, download transaction history related to at least one of an effectuator and an apparatus, establish or change user access criteria, and make and change rules related to an apparatus.

70. A system as described in claim 69, wherein said firmware allows a user to write or re-write rules governing operation of an apparatus of the at least one effectuator via a rules engine.

71. A system as described in claim 70, wherein said rules engine comprises:
at least one of a rule generation user interface, a rule parser and compiler, and a rule execution engine;
wherein any said rule generation user interface generates computer screens and forms that allow a user to add, edit or delete a rule;
wherein any said rule parser and compiler can receive a rule string and transform the string into a format that is most efficient for the rules execution engine; and
wherein any said rules execution engine is responsible for execution of the rule.

72. A system as described in claim 70, wherein rules can be written or re-written by a user of the effectuator at runtime.

73. A system as described in claim 70, wherein a common rule may be shared by other rules.

74. A system as described in claim 69, wherein said software enables a user at the remote device to at least one of: perform effectuator asset audits, perform effectuator alarm audits, monitor and respond to events from an at least one effectuator, and obtain data from an effectuator related to at least one of asset status, alarm status, and hardware status.

75. A system as described in claim 69, wherein some portion of communication between an at least one effectuator and the at least one remote device can be at least one of password authenticated and encrypted.

76. A system as described in claim 69, wherein the system maintains live connection between the at least one effectuator and the at least one remote device with real-time command/event processing instead of polling.

77. A system as described in claim 69, wherein said software is capable of presenting maps of all effectuators that are part of the system, with representative icons on the maps that show where at least one of an effectuator and an apparatus is located, and wherein clicking on an icon on a map will produce at least one of a more localized map with icons, and a status screen displaying status of at least one of an effectuator and an apparatus at the icon location on the last map produced.

78. A system as described in claim 77, where a characteristic of an icon indicates status of at least one of an effectuator and an apparatus.

79. A system as described in claim 69, wherein CRC checksums are used in relation to the database to create a check sum field in each record that compares all the field contents of the current record with all the field contents of the previous record to prevent tampering with the database.

80. A system as described in claim 69, wherein said lockbox has a latch member for latching a lock box opening member closed, said latch member has a lock box frame connection portion whereby it is connected to the lock box frame via a solenoid pin that can be withdrawn to release the latch member from its connection to the lock box and allow opening of the lockbox.

81. A system as described in claim 1, further including a Zigbee Network connecting apparatuses to each other and to an effectuator.

82. A system as described in claim 39, further including a Zigbee Network connecting apparatuses to each other and to an effectuator.

83. A system as described in claim 62, further including a Zigbee Network connecting apparatuses to each other and to an effectuator.

84. A system as described in claim 1, wherein at least one interface page of the firmware can be accessed by a remote device via the communications medium using only a browser.
